(19) United States
(12) Patent Application Publication
(10) Pub. No.: US 2005/0164055 A1
(43) Pub. Date: Jul. 28, 2005

(54) Fuel cell system and power generating method in fuel cell system

(76) Inventors: Kenji Hasegawa, Osaka (JP); Toshiyuki Aoyama, Settsu-shi (JP); Masaru Higashionji, Katano-shi (JP); Masafumi Shimotashiro, Katano-shi (JP); Masayuki Ono, Osaka-shi (JP); Kenya Hori, Tsuyama-shi (JP); Masaru Odagiri, Kawanishi-shi (JP)

Correspondence Address: MCDERMOTT WILL & EMERY LLP, 600 13TH STREET, N.W., WASHINGTON, DC, 20005-3096, US

(21) Appl. No.: 10/998,162

(22) Filed: Nov. 29, 2004

(30) Foreign Application Priority Data
Dec. 17, 2003 (JP) 2003-419485

(51) Int. Cl. H01M 8/04

(52) U.S. Cl. 429/22; 429/34; 429/13

(57) ABSTRACT

A fuel cell system has a controller in communication with a fuel detector for activating power supply if a detection result received from the fuel detector indicates that a level of the liquid fuel has not reached the top of an anode, and for preventing power generation in a fuel cell until the detection result indicates that the level of the liquid fuel has reached the top of the anode.

### TECHNICAL FIELD

The disclosed concepts relate to a fuel cell system composed of a fuel cell body having a membrane electrode assembly disposed between an anode and a cathode disposed so as to face to the anode and auxiliary equipment such as fuel feeding systems for generating electric power in the fuel cell body, and more particularly to a fuel cell system for generating electric power in the fuel cell body while directly feeding organic liquid fuel such as methanol to the anode.

### BACKGROUND

Portable electronic equipment such as cell phones, personal digital assistances, notebook-sized personal computers, portable audios and portable visuals has been becoming popular. Such portable electronic equipment is conventionally driven by primary batteries or secondary batteries. Since the secondary batteries need to be charged after consumption of a specific amount of electric power, they require chargers and charging time. As the secondary batteries, Nickel-Cadmium batteries or lithium-ion batteries are used, and although small-size batteries with high-energy density have been developed, batteries supporting continuous driving for a longer period of time are being demanded.

In order to meet the demand, fuel cell systems operated without charging have been proposed. The fuel cell systems are generators for electrochemically converting chemical energy of fuel to electric energy. Among the fuel cell systems, there is known a Polymer Electrolyte Fuel Cell (PEFC) for generating electric power with use of a perfluorocarbon sulfonic acid-based electrolyte to reduce hydrogen gas in an anode and to reduce oxygen in a cathode. Such PEFC has a feature of batteries with high power density, and its development is being pursued.

However, hydrogen gas used in such PEFC is low in volume energy density, which requires the volume of a fuel tank to be enlarged. Further, the PEFC needs to be equipped with auxiliary equipment such as devices to feed fuel gas and oxide gas to a fuel cell body (generation section) and humidifiers for stabilizing battery performance, which increases the size of a fuel cell system. Therefore, the PEFC is not suitable as a power source for portable electronic equipment.

A Direct Methanol Fuel Cell (DMFC) for generating electric power by directly extracting protons from methanol, although having a disadvantage that its output is smaller than that of the PEFC, allows downsizing since the volume energy density of fuel can be increased and auxiliary equipment of the fuel cell body can be reduced. Because of this reason, the DMFC is drawing attention and several proposals regarding the DMFC have been made.

Reactions due to power generation performed in the fuel cell body of the DMFC are shown in chemical formula (1) prescribing the reaction taken place in the anode and chemical formula (2) prescribing the reaction taken place in the cathode.
CH₃OH+H₂O→6H⁺+6e⁻+CO₂ (1)
6H⁺+6e⁻+3/2O₂→H₂O (2)

As shown in the respective chemical formulas (1) and (2), the power generating operation leads to generation of carbon dioxide (CO₂) in the anode and water (H₂O) in the cathode. Consequently, in order to carry out continuous power generation, it is necessary to treat the produced carbon dioxide and water.

Such a conventional DMFC-type fuel cell system adopts a fuel circulation system in which a pump is used for feeding methanol solution to an anode from a circulation tank containing the methanol solution as a fuel, and the methanol solution fed to the anode is returned to the circulation tank to be recycled as a fuel (see, e.g., U.S. Patent Specification No. 5599638, FIG. 1 and FIG. 2). In the cathode, water is produced by power generation. Thus-produced water is collected by a water collector and fed to the circulation tank containing the methanol solution. In this type of fuel cell system, the methanol solution is fed to the anode through a pipe (such as pipe lines and tubes), by which the methanol solution is fed to a membrane electrode assembly disposed between the anode and the cathode, which is a system of feeding fuel to the membrane electrode assembly through a pipe.

In such a system for feeding fuel to the membrane electrode assembly through a pipe, the structures of the pipe for feeding and circulating fuel and its transportation equipment become large, causing the structure of the entire fuel cell system to be upsized. In order to solve such problems, a fuel cell system of a membrane electrode assembly immersing-type, in which a membrane electrode assembly is immersed in the fuel contained in the fuel container to feed fuel to the membrane electrode assembly without circulation of fuel, is being developed in recent years. A structure example of such type of fuel cell system is shown in FIG. 7.

A fuel cell system 501 in FIG. 7 is constituted from a fuel cell body 502 composed of an anode 551, a cathode 552 and a membrane electrode assembly 553 disposed therebetween, an air pump 557, a product collection vessel 558, a first fuel container 555, a second fuel container 554, a fuel pump 561, a valve 559, and gas-liquid separation membranes 560, 556. The anode 551 of the fuel cell body 502 is disposed inside the first fuel container 555. During operation of the fuel cell, air is introduced from the air pump 557 to the cathode 552, and is discharged from the cathode 552 to the product collection vessel 558. Moreover, the methanol solution contained in the first fuel container 555 is fed into the anode 551 through a fuel feed port 551a that is in the state of being immersed in the methanol solution. The anode 551 has a function to invoke an oxidative reaction of the methanol solution to induce a reaction (anode reaction) to extract protons and electrons. Carbon dioxide, which is produced in the anode 551 as a result of the reaction, is led to the first fuel container 555 through a discharge port 551b disposed on the upper part of the anode 551 as viewed in the drawing, and discharged out of the first fuel container 555 through the gas-liquid separation membrane 560. The second fuel container 554 contains methanol solution to be supplemented to the first fuel container 555. The methanol solution contained in the second fuel container 554 is fed to the first fuel container 555 through the fuel pump 561 and the valve 559.

However, in the conventional fuel cell system 501 shown in FIG. 7, water and methanol (i.e., methanol solution) in the first fuel container 555 sometimes vaporize during stop time for example, and flow to outside through the gas-liquid separation membrane 560, causing the liquid level of the methanol solution in the first fuel container 555 to fall. In such a case, the membrane electrode assembly 553 is exposed out of the liquid level of the methanol solution, and if the membrane electrode assembly 553 is left in such an exposed state, the exposed portion of the membrane electrode assembly 553 is dried up.

Such vaporization (evaporation) of the methanol solution tends to occur when the fuel cell system 501 is not used for a long duration of time, and particularly when electronic equipment having the fuel cell system 501 is left in a high-temperature environment, the internal pressures of the first fuel container 555 and the second fuel container 554 rise and vaporization of the methanol solution is further promoted, by which the membrane electrode assembly 553 is more likely to be in a dry state. If a capacity of the methanol solution contained in the first fuel container 555 is about 200 ml for example, then methanol solution of approx. 2 to 3 ml is evaporated per day.

However, even if the membrane electrode assembly 553 is put in the dry state, the dry state itself will not cause damage on the membrane electrode assembly 553. The membrane electrode assembly 553 can be brought back to the state capable of fulfilling its function by feeding methanol solution into the first fuel container 555 again so as to immerse the membrane electrode assembly 553 in the methanol solution and provide a wet state to the surface of the membrane electrode assembly 553. Consequently, the fuel cell system 501 succeeds to seamlessly generate power afterward.

However, if the fuel cell system 501 is started and electric power is extracted in the state that a part of the membrane electrode assembly 553 is exposed due to lower liquid level of the methanol solution or the membrane electrode assembly 553 is dried up as a result the exposure while other parts thereof are in the wet state, then a voltage of the generated electric power may be dispersed in the membrane electrode assembly, causing polarity to be reversed, i.e., causing polarity reversal. When the polarity reversal occurs in the membrane electrode assembly 553, the membrane itself is damaged and its power generating capability is degraded, causing a problem that the fuel cell system 501 fails to perform stable power generation.

A specific example of experimental data regarding the case where the membrane electrode assembly is damaged is shown below.

With use of the fuel cell system of a membrane electrode assembly immersing-type as a fuel cell system, outputs during power generation in the case where fuel reaches the entire anode-side surface of the membrane electrode assembly (i.e., the case where the entire surface is immersed in the fuel) and in the case where fuel does not yet reach a part of the anode-side surface were compared. It is to be noted that that other conditions during power generation in respective cases were the same and comparison of the outputs were conducted with a constant current.

In the case of generating electric power in the fuel cell body and extracting the electric power in the state that fuel reaches the entire anode-side surface of the membrane electrode assembly, an output per unit area of the membrane electrode assembly was 50 mW/cm².

In the case of generating electric power in the fuel cell body and extracting the electric power in the state that fuel reaches only approx. 80% of the surface area of the anode-side surface on the membrane electrode assembly, an output per unit area was 30 mW/cm², and continuous power generation in this state decreased the output to the point that no-output was yielded.

In the case where the power generating operation was stopped afterward to supplement fuel to the anode so that fuel reaches the entire anode-side surface of the membrane electrode assembly, and then electric power was generated and extracted again in the state that the fuel reached the surface, an output per unit area was approx. 25 mW/cm², and recovery of the output was not observed. In this state, the equipment to which electric power is fed suffers power shortage, making the equipment unusable.

Thus, in the state that a part of the membrane electrode assembly is exposed, fuel is only partially fed to the membrane electrode assembly, causing unstable outputs, and further, exposure of the fuel feed port disables fuel contained in the anode from sufficiently gaining convection, causing insufficient fuel feeding, which are presumed to be causes of the above-stated problem Further, it is considered that generating electric power in the fuel cell body and extracting the electric power in this state damage a portion of the membrane electrode assembly that is not in contact with the fuel, and even if the portion is brought into contact with the fuel afterward, an originally expected output density cannot be achieved in the already damaged state.

Such problem as the damage on the membrane electrode assembly 553, which is triggered by generation of the state that the membrane electrode assembly 553 is exposed out of the methanol solution or the resultant dry (particularly partial dry) state and which is also triggered by startup of the fuel cell system 501, has not drawn attention in the conventional fuel cell systems, but is a newly found problem particularly in the fuel cell system of the membrane electrode assembly immersing-type which is being developed in recent years, and the problem is also shared by various kinds of fuel cell systems having the membrane electrode assembly.

In view of the improvement of power generating efficiency in the fuel cell system 501, the membrane electrode assembly 553 inside the first fuel container 555 (or inside the anode 551) should preferably have a large membrane area efficiency. Consequently, the membrane electrode assembly 553 is set inside the first fuel container 555 (or inside the anode 551) in such a way that a large surface area is secured. In such a case, however, rise and fall of the methanol solution contained in the first fuel container 555 tends to exert more influence on the exposure of the membrane electrode assembly 553 out of the liquid level, making the aforementioned problem of damage infliction more significant.

### SUMMARY

Accordingly, in order to solve the above problems, the disclosed concepts include a fuel cell system for generating electric power by feeding liquid fuel to a membrane electrode assembly, which is capable of prevent the membrane electrode assembly from being exposed out of the liquid fuel due to vaporization of the liquid fuel or the like during stop time of the fuel cell system and stabilizing restart of the fuel cell system, and to provide a power generating method thereof.

In accomplishing these and other aspects, according to a first aspect, there is provided a fuel cell system comprising:
a fuel cell including an anode, a cathode disposed so as to face the anode, and a membrane electrode assembly disposed between the anode and the cathode;
a fuel pump for feeding liquid fuel to the anode wherein the anode is immersed when the liquid fuel reaches a top of the anode;
a fuel detector for detecting a level of the liquid fuel relative to the top of the anode;
a power supply for feeding electric power necessary for driving the fuel pump; and
a controller in communication with the fuel detector for activating the power supply if a detection result received from the fuel detector indicates that a level of the liquid fuel has not reached the top of the anode, and for preventing power generation in the fuel cell until the detection result indicates that the level of the liquid fuel has reached the top of the anode.

According to a second aspect, there is provided a fuel cell system comprising:
a fuel cell including an anode, a cathode disposed so as to face the anode, and a membrane electrode assembly disposed between the anode and the cathode;
a first fuel container in which at least the anode of the fuel cell is disposed for containing liquid fuel;
a second fuel container for containing liquid fuel having a concentration higher than that of the liquid fuel contained in the first fuel container; and
a fuel pump for feeding the liquid fuel from the second fuel container to the first fuel container during a power generating operation in the fuel cell; and
a switch valve disposed between the first fuel container and the second fuel container operative to feed the liquid fuel from the second fuel container to the first fuel container during a time when the power generation has stopped.

According to a third aspect, there is provided a fuel cell system comprising:
a fuel cell including an anode, a cathode disposed so as to face the anode, a membrane electrode assembly disposed between the anode and the cathode, and a power generating circuit for connecting the anode and the cathode;
a fuel container in which at least the anode of the fuel cell is disposed for containing the liquid fuel;
a content detector for detecting a content of the liquid fuel in the fuel container;
a circuit-breaking switch for activating the power generating circuit during the power generating operation, and for deactivating the power generating circuit during a stop time of the power generation; and
a controller for changing the circuit-breaking switch to a deactivating position or for maintaining the deactivating position when the content detector detects a content of the liquid fuel with which at least a part of the anode is exposed out of the liquid fuel contained in the fuel container.

According to a fourth aspect, there is provided a fuel cell system comprising;
a fuel cell including an anode which has a passageway of liquid fuel, a cathode disposed so as to face the anode and a membrane electrode assembly disposed between the anode and the cathode;
a fuel pump for feeding liquid fuel to the anode by passing through the liquid fuel form an inlet to an outlet of the passageway;
a fuel detector for detecting that the liquid fuel reaches the outlet of the passageway in the anode;
a power supply for feeding electric power necessary for driving the fuel pump; and
a controller in communication with the fuel detector for activating the power supply if a detection result received from the fuel detector indicates that the liquid fuel has not reached the outlet of the passageway in the anode, and for preventing power generation in the fuel cell until the detection result indicates that the liquid fuel has reached the outlet of the passageway.

According to yet another aspect, a fifth aspect, there is provided a power generating method in a fuel cell system made up of a fuel cell including an anode, a cathode and a membrane electrode assembly, a first fuel container for containing liquid fuel, and a second container for containing a liquid fuel concentrate with a concentration higher than that of the liquid fuel, the method comprising the steps of:
immersing the anode in the liquid fuel during a stop time of power generation in the fuel cell; and
supplementing liquid fuel consumed by the power generation in the first container during the power generating operation in the fuel cell in order to perform continuous generation of a specified amount of electric power in the fuel cell.

According to even another aspect, a sixth aspect, there is provided a power generating method in a fuel cell system, comprising the steps of:
before staring power generation in a fuel cell, detecting whether or not an anode is immersed in liquid fuel, and
feeding liquid fuel to the anode if it is determined based on a detection result that the anode is not immersed in liquid fuel until the anode is immersed in liquid fuel; and
generating power in the fuel cell after the anode is immersed in liquid fuel.

### BRIEF DESCRIPTION OF THE DRAWINGS

These and other objects and features of the disclosed concepts will become clear from the following description taken in conjunction with the preferred embodiments thereof with reference to the accompanying drawings, in which:

FIG. 1 is a schematic structural view showing a fuel cell system in a first embodiment;

FIG. 2 is a flowchart showing the procedures to start power generation in the fuel cell system of FIG. 1;

FIG. 3 is a schematic structural view showing a fuel cell system in a second embodiment;

FIG. 4 is a schematic structural view showing a fuel cell system in a third embodiment;

FIGS. 5A, 5B and 5C are enlarged schematic views each showing a fuel feed section (A section) in the fuel cell system of FIG. 4, in which FIG. 5A is a schematic view showing the state that the liquid level of an intermediate tank is at a height position almost identical to that of a feed-side end portion of a water feed pipe, FIG. 5B is a schematic view showing the state that the liquid level is positioned slightly above the feed-side end portion of a first fuel feed pipe, and FIG. 5C is a schematic view showing the state that the liquid level is positioned below the feed-side end portion of the first fuel feed pipe;

FIGS. 6A and 6B are perspective views showing the fuel cell system in the first embodiment, the second embodiment or the third embodiment in the state of being mounted on a notebook-sized personal computer as a fuel cell pack; in which FIG. 6A is a perspective view showing the personal computer with the display panel in open state, and FIG. 6B is a perspective view showing the personal computer with the display panel in close state;

FIG. 7 is a schematic structural view showing a conventional fuel cell system;

FIG. 8 is a fragmentary structural view showing a fuel cell system in a modified example of the first embodiment;

FIG. 9 is a perspective view showing with arrows the fuel cell system taken along line V-V of FIG. 8;

FIG. 10 is a schematic view showing the fuel cell system of FIG. 9 disposed in the state of being inclined;

FIG. 11 is an enlarged schematic view showing an upper housing section of an anode in the fuel cell system of FIG. 8;

FIG. 12 is a schematic perspective view showing a fuel cell body in a modified example of the first embodiment; and

FIGS. 13A, 133, and 13C are schematic views showing an anode of the fuel cell body of FIG. 12, in which FIG. 13A is showing the anode at a front face, FIG. 13B is showing the anode at a side face, and FIG. 13C is showing the anode at a back face.

### DETAILED DESCRIPTION

Before the description proceeds, it is to be noted that like parts are designated by like reference numerals throughout the accompanying drawings.

The first embodiment will be described hereinbelow in detail with reference to the drawings.

### First Embodiment

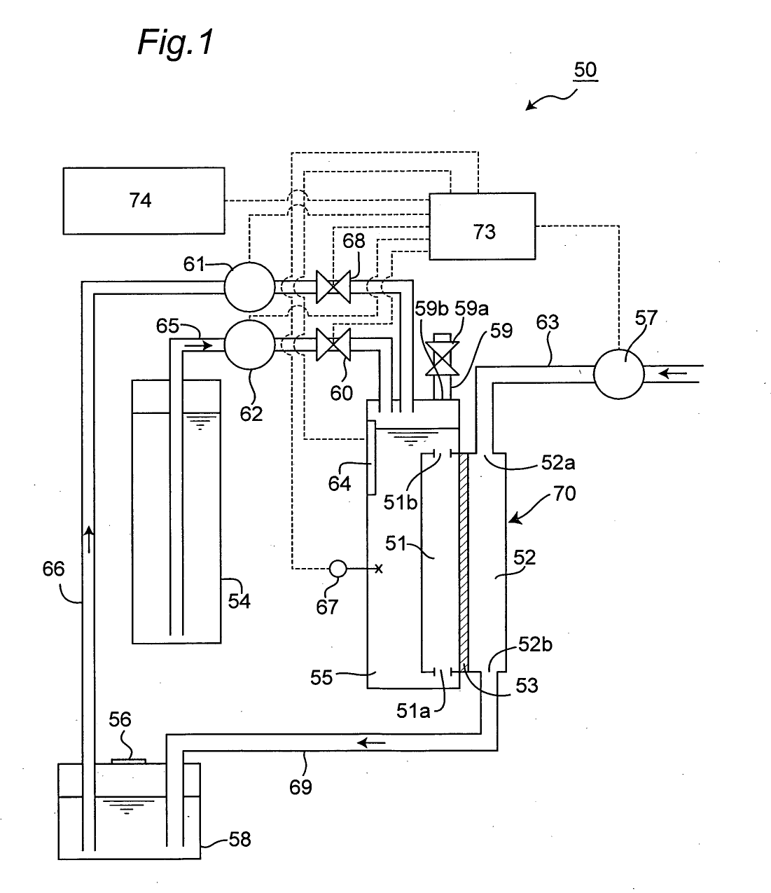

The schematic structural view showing the schematic structure of a fuel cell system 50 according to the first embodiment is illustrated in FIG. 1.

As shown in FIG. 1, the fuel cell system 50 has a fuel cell body 70 that is a power generating section for generating electric power by electrochemically converting chemical energy of fuel to electric energy, and an auxiliary equipment system for performing auxiliary operations for power generation such as feeding fuel or the like necessary for the power generation to the fuel cell body 70. Moreover, the fuel cell system 50 is a Direct Methanol Fuel Cell (DMFC) for generating electric power with use of a methanol solution exemplifying organic liquid fuel as fuel by directly extracting protons from the methanol.

As shown in FIG. 1, the fuel cell body 70 has an anode (fuel pole) 51, a cathode (air pole) 52 and a membrane electrode assembly 53. The anode 51 has a function to invoke an oxidative reaction of the fed methanol solution to induce a reaction (anode reaction) to extract protons and electrons. The electrons move to the cathode 52 through a power generating circuit (unshown) which electrically connects the anode 51 and the cathode 52 via respective electrodes (unshown), whereas the protons move to the cathode 52 through the membrane electrode assembly 53. Further, the cathode 52 has a function to set off a reaction (cathode reaction) to produce water through a reduction reaction with use of oxygen fed from the outside, the protons moved from the anode 51 through the membrane electrode assembly 53, and the electrons flowing in through the power generating circuit. Thus, an oxidative reaction in the anode 51 and a reduction reaction in the cathode 52 are respectively performed and electrons are sent through the power generating circuit, so that current is generated to allow power generation.

More specifically, the fuel cell body 70 may be formed by using a Nafion 117 (trademark or trade name) made by DuPont as an electrolyte, forming carbon powder carriers with platinum and ruthenium, or an alloy of platinum and ruthenium being dispersed therein as an anode catalyst of the anode 51 on one surface of the electrolyte while forming carbon carriers with platinum particles being dispersed therein as a cathode catalyst of the cathode 52 on the other surface, then placing diffusion layers made of, for example, carbon paper respectively on the anode catalyst and the cathode catalyst in intimate contact so as to form a membrane electrode assembly 53, and then fixing the membrane electrode assembly 53 to a housing through separators.

Further, as shown in FIG. 1, the anode 51 has a fuel feed port 51a provided inside for feeding a methanol solution so as to allow the anode reaction to be set off and a discharge port 51b for discharging carbon dioxide produced by the anode reaction and a remaining methanol solution not used in the reaction from the inside.

The cathode 52 uses, for example, air, for feeding oxygen for use in the cathode reaction and therefore has an air feed port 52a for feeding the air to the inside of the cathode 52, and a discharge port 52b for discharging water (including water in both liquid phase or gas phase, and water in the mixed state of the both phases) that exemplifies the product produced by the cathode reaction from the inside. It is to be noted that the product contains water as a primary ingredient, and may contain other ingredients such as formic acid, methyl formate and methanol (by cross over).

Description is now given of the structure of the auxiliary equipment system in the fuel cell system 50. The auxiliary equipment system has auxiliary equipment for feeding a methanol solution to the anode 51 of the fuel cell body 70, auxiliary equipment for feeding air to the cathode 52, and auxiliary equipment for collecting water, i.e., a product produced in the cathode 52.

First, as shown in FIG. 1, the auxiliary equipment for the fuel feeding has an intermediate tank 55 exemplifying the first fuel container (or exemplifying the fuel container) for containing a methanol solution as liquid fuel so as to be fed to the anode 51, a liquid concentrate tank 54 exemplifying the second fuel container for containing a methanol solution with a concentration higher than that of the methanol solution contained in the intermediate tank 55 as liquid fuel concentrate so as to be fed to the intermediate tank 55, and a fuel feed unit for feeding the liquid fuel concentrate contained in the liquid concentrate tank 54 to the intermediate tank 55. It is to be noted that the liquid concentrate tank 54 is, for example, a cartridge-type container mountable on the fuel cell system 50. In the fuel cell system 50, liquid fuel concentrate can be supplemented by dismounting the liquid concentrate tank 54 empty of the liquid fuel contained therein and mounting a new liquid concentrate tank 54 filled with liquid fuel.

The fuel feed unit has a fuel feed pipe 65 exemplifying a fuel passageway connecting the liquid concentrate tank 54 and the intermediate tank 55, a fuel pump 62 provided at some midpoint of the fuel feed pipe 65 for feeding liquid fuel contained in the liquid concentrate tank 54 to the intermediate tank 55 through the fuel feed pipe 65, and an automatic valve 60 provided in the fuel feed pipe 65 in the vicinity of a discharge-side of the fuel pump 62 for selectively open and close the fuel feed pipe 65 based on an external signal. The fuel feed pipe 65 is disposed such that one end is positioned in the vicinity of the internal bottom portion of the liquid concentrate tank 54 while the other end, that is an end portion of the fuel feeding to the intermediate tank 55, is disposed so as to be at a position slightly higher than the upper portion of the anode 51 disposed inside the intermediate tank 55.

Further, as shown in FIG. 1, the anode 51 is disposed in the inner space of the intermediate tank 55, so that the entire anode 51 is completely immersed in the liquid fuel contained in the intermediate tank 55 in a fill-up state, i.e., the anode 51 is disposed below the liquid level of the contained liquid fuel. Thus, disposing the anode 51 in the intermediate tank 55 makes it possible to feed the liquid fuel into the anode 51 through the fuel feed port 51a that is constantly in the state of being immersed in the liquid fuel. Moreover, since the liquid fuel can be fed into the anode 51, the entire anode-side surface of the membrane electrode assembly 53 can be immersed in the liquid fuel, making it possible to constantly put the surface of the membrane electrode assembly 53 in a wet state. In other words, the membrane electrode assembly 53 is disposed in an immersed state below the liquid level of the liquid fuel contained in the intermediate tank 55.

Further, gases such as carbon dioxide produced in the anode reaction performed in the anode 51 flow into the intermediate tank 55 through the discharge port 51b of the anode 51. In order to discharge the gases flowing into in this manner out of the intermediate tank 55, there is provided a discharge pipe 59, which is composed of a valve 59a and a gas-liquid separation membrane 59b (may be composed of a sheet made of Teflon (trademark) or the like) It is to be noted that the discharge pipe 59 may function as a gas vent during initial injection of liquid fuel to the intermediate tank 55.

Further, the intermediate tank 55 is equipped with a concentration sensor 67 exemplifying the concentration detection unit capable of detecting the concentration of liquid fuel contained therein. It is to be noted that the concentration sensor 67 may use ultrasonic, capacitance or near-infrared multiwavelength optical concentration sensors.

Further, the intermediate tank 55 is equipped with a level sensor 64 capable of detecting the liquid level of the liquid fuel contained therein. The level sensor 64 is capable of detecting a liquid level at which the entire anode-side surface of the membrane electrode assembly 53 may be completely immersed in the liquid fuel contained in the intermediate tank 55. It is to be noted that in the first embodiment, the level sensor 64 exemplifies the fuel detection section.

From the view point that, for example, the fuel pump should be a small-size pump with small power consumption and that controlling the drive time of the fuel pump should enable a feed amount of the liquid fuel concentrate to be controlled, a small-size positive displacement pump or the like should preferably be used as the fuel pump 62. In the first embodiment, for example, there is used a solenoid-operated pump (a check valve incorporated, discharge rate: 0-4 ml/min., discharge pressure: 10 kPa), which in use can be, for example, intermittently driven to send out an appropriate amount of liquid fuel concentrate.

Further, the intermediate tank 55 contains, as the liquid fuel, a methanol solution with any concentration in the range of, at percent by weight, 1 to 10 wt %, preferably in the range of 3 to 10 wt %. In the initial state, the intermediate tank 55 contains a methanol solution with a concentration of 4.5 wt %. The liquid concentrate tank 4 contains a methanol solution higher in concentration than the liquid fuel contained in the intermediate tank 5 or methanol concentrate (i.e., methanol with a concentration of 100 wt %). In the initial state, for example, the liquid concentrate tank 4 contains a methanol solution with a concentration of 68 wt %.

Next, the auxiliary equipment for air feeding has an air feed pipe 63 exemplifying the air feed passageway whose one end is connected to the air feed port 52a of the cathode 52, and an air pump 57 exemplifying the oxygen feed unit (or exemplifying the air feed pump) disposed at some midpoint of the air feed pipe 63 for feeding air into the cathode 52 through the air feed pipe 63. As the air pump 57, a small-size pump with small power consumption should be preferably used. For example, there is used a motor operated pump (a check valve incorporated, discharge rate: 4 L/min., discharge pressure: 50 kPa), which in use feeds air at, for example, 3 L/min. Moreover, when power generation is executed in the fuel cell body 70, the air pump 57 is driven to feed necessary oxygen into the cathode 52, while when the power generation is stopped, the air pump 57 is stopped driving. It is noted that when the power generation is stopped, the fuel pump 62 is also stopped driving, and at the same time, the automatic valve 60 provided in the fuel feed pipe 65 is closed to interrupt the fuel feed pipe 65 so that the connection between the liquid concentrate tank 54 and the intermediate tank 55 can be blocked.

Further, the auxiliary equipment for collecting water produced in the cathode has a discharge port 52b of the cathode 52, a water tank 58 exemplifying the product collecting container for collecting water produced in the cathode 52, and a water collection pipe 69 exemplifying the product collection passageway for connecting the discharge port 52b of the cathode 52 and the water tank 58 so that the above-produced water is collected into the water tank 58 from the discharge port 52b. Further, the water tank 58 is provided with a gas-liquid separation membrane 56 for discharging gases, i.e., air, introduced into the water tank 58 in the state of being mixed in the collected water, out of the water tank 58. Moreover, there is provided a water feed pipe 66 exemplifying the product feed passageway for connecting the water tank 58 and the intermediate tank 55 for feeding water collected in the water tank 58 to the intermediate tank 55. At some midpoint of the water feed pipe 66, there are provided a water pump 61 exemplifying the product power feed section for feeding water with effect of power (electrical power) and an automatic valve 68 for opening and closing the water feed pipe 66 based on an external signal. It is to be noted in the first embodiment, the water feed pipe 66 and the water pump 61 constitute an example of the product feed unit. Further, in feeding water to the intermediate tank 55, controlling the operating time of the water pump 61 so that a concentration of liquid fuel in the intermediate tank 55 detected by the concentration sensor 67 should be a desired concentration for example, makes it possible to feed a necessary amount of water to the intermediate tank 55 through the water feed pipe 66 and the water pump 61.

Further, thus-structured fuel cell system 50 is equipped with a control unit 73 for controlling the operation of respective units and component members. The control unit 73 is capable of controlling a liquid fuel feed operation by the fuel pump 62, an air feed operation by the air pump 57, and a methanol solution concentration control in the intermediate tank 55 in the fuel cell system 50 in a comprehensive manner while associating the respective operations to each other.

More precisely, the control unit 73 controls so as to drive the air pump 57 when power generation is executed in the fuel cell body 70 and to stop driving of the air pump 57 when the power generation is stopped. Moreover, the control unit 73 is also capable of performing control for stopping driving of the fuel pump 62 as well as control on the opening and closing operation of the automatic valves 60, 68 at the same time as the air pump 57 is stopped driving.

Further, the control unit 73 is capable of controlling a feed amount of liquid fuel concentrate to the intermediate tank 55 and a collection amount of water collected (i.e., a feed amount of water) depending on the concentration of liquid fuel contained in the intermediate tank 55 detected by the concentration sensor 67. More specifically, the driving time of the fuel pump 62 and the driving time of the water pump 61 can be controlled depending on the detected concentration so that the liquid fuel contained in the intermediate tank 55 is maintained in a specified concentration range which is pre-determined in the control unit 73. The concentration range pre-determined in the control unit 73 herein refers to the concentration range of the methanol solution which allows generation of necessary electric power (necessary voltage and current) in the fuel cell body 70, which is set, for example, to be the concentration range of 10 wt % to 1 wt %, more preferably 10 wt % to 3 wt %. It is to be noted that such concentration range that allows power generation is attributed to the cross over characteristic of the membrane electrode assembly 53. Therefore, if the cross over characteristic is improved and so an amount of methanol fed from the anode 51 to the cathode 52 through the membrane electrode assembly 53 is reduced, then the concentration range of 10 wt % or higher can be set as the concentration range that allows power generation.

Further, the fuel cell system 50 has a secondary battery 74 exemplifying the power feed unit which can feed electric power for driving each auxiliary equipment system even when power generating operation is not executed by the fuel cell body 70 and so the electric power by the power generation is not fed thereto. As the secondary battery 74, lithium-ion batteries which are small in size and small in cubic content or the like may be used. Any secondary battery in various types other than the lithium-ion batteries may be adopted as long as they can feed electric power for driving auxiliary systems. Moreover, the power feed unit is not limited to the secondary battery, and therefore power generating devices such as double-layer electrolytic capacitors and solar batteries may be used as long as they can feed electric power different from the electric power generated by power generating operation by the fuel cell body 70.

Further, even during stop time of power generation by the fuel cell body 70, the secondary battery 74 is capable of feeding the electric power for the control unit 73 to function, feeding the electric power for driving the fuel pump 62, the water pump 61 and the air pump 57, feeding the electric power for driving the opening and closing operation of the automatic valves 60 and 68, and further feeding the electric power for the level sensor 64 to function. It is to be noted that the electric power fed from the secondary battery may be referred to as secondary electric power for distinguishing the electric power fed by the secondary battery 74 and the electric power generated by power generating operation in the fuel cell body 70.

Moreover, the control unit 73 is capable of performing such control over fuel supplement as detecting a content of the liquid fuel contained in the intermediate tank 55 by the level sensor 64, driving the fuel pump 62 based on the detection result to feed the liquid fuel concentrate from the liquid concentrate tank 54 to the intermediate tank 55 so that the entire anode-side surface of the membrane electrode assembly 53 is completely immersed in the liquid fuel, and stopping feed of the liquid fuel concentrate upon detection of the immersing by the level sensor 64.

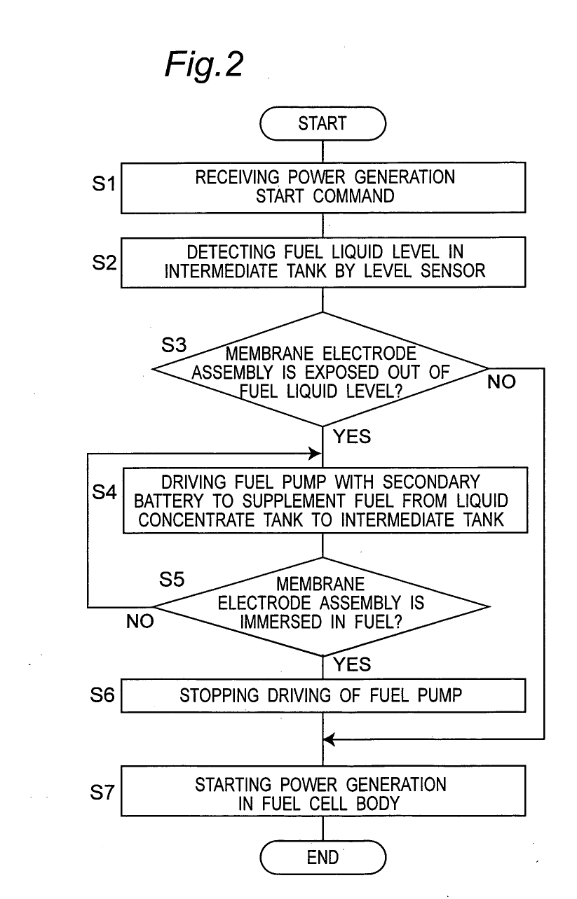

Description is now given of the operation of respective units and component members when power generation is executed in thus-structured fuel cell system 50 based on the flowchart prescribing the power generation staring procedures shown in FIG. 2. It is to be noted that the operation control over respective units and component members described hereinafter is performed by the control unit 73 in a comprehensive manner while the respective operations are associated to each other.

First, in the fuel cell system 50 shown in FIG. 1, a methanol solution (liquid fuel) with a concentration of, for example, 4.5 wt % is contained in the intermediate tank 55, while a methanol solution (liquid fuel concentrate) with a concentration of, for example, 68 wt % is contained in the liquid concentrate tank 54. The liquid fuel contained in the intermediate tank 55 is fed to the anode 51 through the fuel feed port 51a. Moreover, a content of the methanol solution in the intermediate tank 55 is basically a content with which the anode 51 disposed inside the intermediate tank 55 is completely immersed in the methanol solution. Thus, containing the methanol solution in the intermediate tank 55 puts the anode-side surface of the membrane electrode assembly 53 in a state of being immersed in the methanol solution.

However, due to the use environment, the use condition or the like of the fuel cell system 50, i.e., in the case where, for example, the fuel cell system 50 is left in a high-temperature environment or not used for a long period of time, part of liquid fuel contained in the intermediate tank 55 may be evaporated and discharged out of the intermediate tank 55, while inside the intermediate tank 55, the liquid level of the liquid fuel contained therein may fall and a part of the membrane electrode assembly 53 may be exposed out of the liquid level.

Under such a condition, the fuel cell system 50 receives a power generation start command in step S1 in the flowchart in FIG. 2. For example, upon power-on of a portable electronic equipment or the like on which such a fuel cell system 50 is mounted, the power generation staring command signal is inputted to the control unit 73. It is to be noted that at this point, power generation by the fuel cell system 50 is not yet started (i.e., electric power is not yet generated by the power generating operation), so that the electric power necessary for the control unit 73 to function is fed from the secondary battery 74.

In the control unit 73, based on the power generation start command, the liquid level of the liquid fuel contained in the intermediate tank 55 is detected by the level sensor 64 (step S2). It is to be noted that the electric power necessary for the detection by the level sensor 64 is fed from the secondary battery 74. The detection result provided by the level sensor 64 is inputted to the control unit 73, which determines whether or not the detected liquid level reached a pre-determined liquid level (step S3). More specifically, the control unit 73 determines whether or not the entire anode-side surface of the membrane electrode assembly 53 is completely immersed in the contained liquid fuel. The pre-determined liquid level refers to a liquid level which allows the membrane electrode assembly 53 to be immersed in this manner.

If it is determined by the control unit 73 based on the determination in the step S3 that the above-stated pre-determined liquid level is not reached, i.e., if at least a part of the anode-side surface of the membrane electrode assembly 53 is exposed out of the liquid level, then the control unit 73 opens the automatic valve 60, while driving the fuel pump 62 to feed liquid fuel concentrate from the liquid concentrate tank 54 to the intermediate tank 55 through the fuel feed pipe 65 (step S4). It is to be noted that the electric power necessary for driving the fuel pump 62 and driving the automatic valve 60 at this point is fed from the secondary battery 74. After that, the liquid level of the intermediate tank 55 to which the liquid fuel concentrate is fed is again detected by the level sensor 64 in step S5, and based on the detection result, feeding of the liquid fuel concentrate (step S4) is continued till the pre-determined liquid level is fulfilled.

Then, in the step S5, if it is confirmed that a content of the liquid fuel in the intermediate tank 55 reached the pre-determined liquid level, then driving of the fuel pump 62 by the secondary battery 74 is stopped (step S6).

In such a condition, the entire anode-side surface of the membrane electrode assembly 53 is in the state of being in contact with the liquid fuel, i.e., the liquid fuel is in the state of reaching the entire membrane electrode assembly 53, and therefore there is no portion on the anode-side surface of the membrane electrode assembly 53 that is in a dry state without being in contact with the liquid fuel. Only after this state is gained, the fuel cell body 70 enters the state that allows start of power generation. Then, in step S7, the control unit 73 starts power generation in the fuel cell body 70, and electric power is generated by the power generating operation.

In the step S3, if it is determined based on the detection result provided by the level sensor 64 that the pre-determined liquid level reached, i.e., if it is determined that the detected liquid level is the level at which the membrane electrode assembly 53 is not exposed out of it, then the procedures from the step S4 to S6 are skipped and power generation in the fuel cell body 70 is promptly started in the step S7. Thus, with the various procedures, power generation in the fuel cell system 50 is started.

It is to be noted that it is also acceptable that a signal to allow start of power generation may be created by the control unit 73 and outputted to the outside of the fuel cell system 50 or the like after the fuel cell body 70 is put in the state allowing power generation.

Further, it has been described in the above-stated respective procedures that whether or not the liquid fuel reached the entire anode-side surface of the membrane electrode assembly 53 is detected by the level sensor 64 by detecting a content of the liquid fuel in the intermediate tank 55 in the step S5 in FIG. 2. However, the method for detecting the reach of the liquid fuel is not limited to the one described above. Instead of the above-stated method, it is also acceptable to, for example, detect a content of the liquid fuel in the intermediate tank 55 when detecting the liquid level of the intermediate tank 55 in the step S2, calculating a supplement amount or supplementing time of the liquid fuel based on the detection result, and detecting that the supplement amount or the supplementing time by the fuel pump 62 meet the above-calculated condition.

It is to be noted that in the operations till the start of power generation in the fuel cell body 70, whether or not the entire anode-side surface of the membrane electrode assembly 53 is completely immersed in the liquid fuel is used as a determination criterion for supplement of the liquid fuel. The wording “the entire surface is completed immersed” herein means that the entire anode-side portion of the membrane electrode assembly 53 which is substantially responsible for the power generation is completed immersed. More specifically, it signifies that the entire joint (contact) portion between the electrolyte and the anode catalyst in the membrane electrode assembly 53 is completely immersed.

Description is hereinbelow given of the operations after start of power generation in such a fuel cell body 70.

First of all, the air pump 57 is driven by the electric power fed from the secondary battery 74, and air, i.e., oxygen, is fed through the air feed pipe line 63 and the air feed port 52a. By this, an anode reaction is performed in the anode 51 while a cathode reaction is performed in the cathode 52. Consequently, electric power is generated between the anode 51 and the cathode 52 or in the power generating circuit. Carbon dioxide generated by the anode reaction in the anode 701 goes into the intermediate tank 55 through the discharge port 51b, and further goes through the gas-liquid separation membrane 59b of the intermediate tank 55 before discharged out of the intermediate tank 55. At the time of generating electric power, the liquid fuel is in the state of reaching the entire anode-side surface of the membrane electrode assembly 53, which prevents generation of a partial reaction nor the polarity reversal.

Water generated by the cathode reaction in the cathode 52 is sent to the water collection pipe 57 through the discharge port 52b by the pressure applied to the inside of the cathode 52 by the air pump 57, and transferred to the water tank 58 through the water collection pipe 69 and collected therein. It is to be noted that the air pump 57 driven by the secondary battery 74 is then switched to be driven by the electric power generated in the fuel cell body 70.

Further, by execution of the power generation, methanol and water from the methanol solution contained in the intermediate tank 55 are consumed. Consequently, in the intermediate tank 55, a fluid volume of the methanol solution decreases while a concentration of the methanol solution drops. By detecting the dropped concentration by the concentration sensor 67, a feed amount (supplement amount) of liquid fuel concentrate to the intermediate tank 55 and a collection amount (supplement amount) of collected water are determined in the control unit 73. Based on the determined respective feed amounts, the above feed amount of liquid fuel concentrate is fed from the liquid concentrate tank 54 to the intermediate tank 55 through the fuel feed pipe 65 and the fuel pump 62, while the above feed amount of water is fed from the water tank 58 to the intermediate tank 55 through the water pump 61, the automatic valve 68 and the water feed pipe 66. By such feed operation of the liquid fuel concentrate and water to the intermediate tank 55, liquid fuel contained in the intermediate tank 55 is supplemented, while the concentration is maintained in the specified concentration range. Such operation is continuously and repeatedly performed in the fuel cell system 50, by which a necessary amount of electric power (specified electricity amount) is continuously generated in the fuel cell body 70.

When power generation is stopped in the fuel cell system 50, the driving of the air pump 57, the driving of the fuel pump 62, and the driving of the water pump 61 are stopped. Further, respective automatic valves 60, 68 are operated to block the fuel feed pipe 65 and the water feed pipe 66. Such state is a power generation stopped state in the fuel cell system 50, and this state is maintained when power generation is not executed.

It is to be noted that the above description discussed the case where, before start of power generation in the fuel cell body 70, the fuel pump 62 is driven by the secondary battery 74 to feed the liquid fuel concentrate depending on a content of the liquid fuel in the intermediate tank 55, by which a content of the liquid fuel contained in the intermediate tank 55 is supplemented. In such supplementing method, various modified example may be further applied.

In one of such modified examples, for example, when feeding of the liquid fuel concentrate by the fuel pump 62 is started or the liquid fuel concentrate is in the middle of the feeding, the concentration of the liquid fuel contained in the intermediate tank 55 is detected by the concentration sensor 67. The control unit 73 determines whether or not the detection result exceeds an upper limit of the pre-determined concentration range, and if it is determined that the result does not exceed, then the feed operation of the liquid fuel concentrate by the fuel pump 62 is promptly started or continued.

If it is determined that the result exceeds the concentration range, then the driving of the fuel pump 62 is stopped, while the automatic valve 68 is opened and the water pump 61 is driven by the electric power from the secondary battery 74 for feeding water contained in the water tank 58 to the intermediate tank 55. Feeding water in this way makes it possible to confine the concentration of the liquid fuel contained in the intermediate tank 55 in the aforementioned concentration range.

It is to be noted that the aforementioned pre-determined concentration range refers to a concentration range which is determined by the capability of the membrane electrode assembly 53, i.e., a concentration range which allows the membrane electrode assembly 53 to generate electric power.

Further, liquid fuel may be supplemented by feeding both liquid fuel concentrate and water based on a specified ratio or the like instead of based on the concentration detection result of the liquid fuel in the intermediate tank 55.

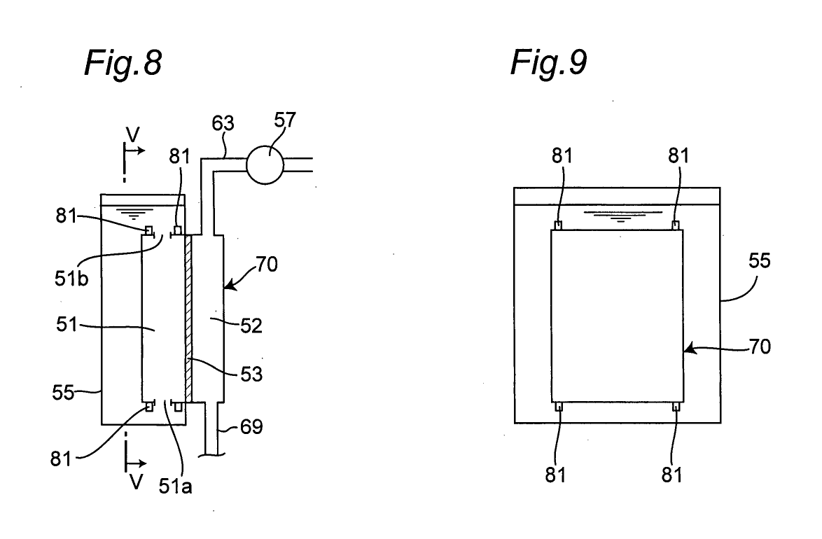

Further, although the above description discussed the case where in the fuel cell system 50, the fuel detection section for detecting whether or not the liquid fuel reached the entire anode-side surface of the membrane electrode assembly 53 is the level sensor 64, the fuel detection section is not limited to this. In a schematic explanatory view of FIG. 8, there is shown the structure of a fuel cell system having a plurality of liquid detection sensors 81 disposed in place of the above level sensor as an example of the fuel detection section on the outer circumference of a housing of the anode 51 in the fuel cell body 70. It is to be noted that the schematic explanatory view of FIG. 8 shows the fuel cell body 70 in the vicinity of the intermediate tank 55, and FIG. 9 shows with arrows a perspective view taken along line V-V of FIG. 9.

As shown in FIG. 8 and FIG. 9, total four liquid detection sensors 81 are provided on the top surface and the bottom surface as viewed in the drawing on the outer circumference of the housing of the anode 51 in the fuel cell body 70, and as shown in FIG. 9 for example, respective liquid detection sensors 81 are disposed in the vicinity of end portions of horizontal direction as viewed in the drawing on each plane. More specifically, as shown in an enlarged perspective view showing the top surface of the housing of the anode 51 in FIG. 11, the liquid detection sensors 81 are disposed in the vicinity of an almost diagonal corner portions so as to get clear of the fuel feed port 51b on the top surface of the outer circumference of the housing. These liquid detection sensors 81 are sensors having a function to detect the contact with liquid, and may make use of, for example, thermistor-type liquid detection sensors.

Further, each of these liquid detection sensors 81 is capable of separately detecting the contact with liquid fuel, while inputting the detection result to the control unit 73. It any one of the four liquid detection sensors 81 is out of contact with the liquid fuel, then it can be determined in the control unit 73 that there is a portion of the membrane electrode assembly 53 which is exposed out of the liquid level.

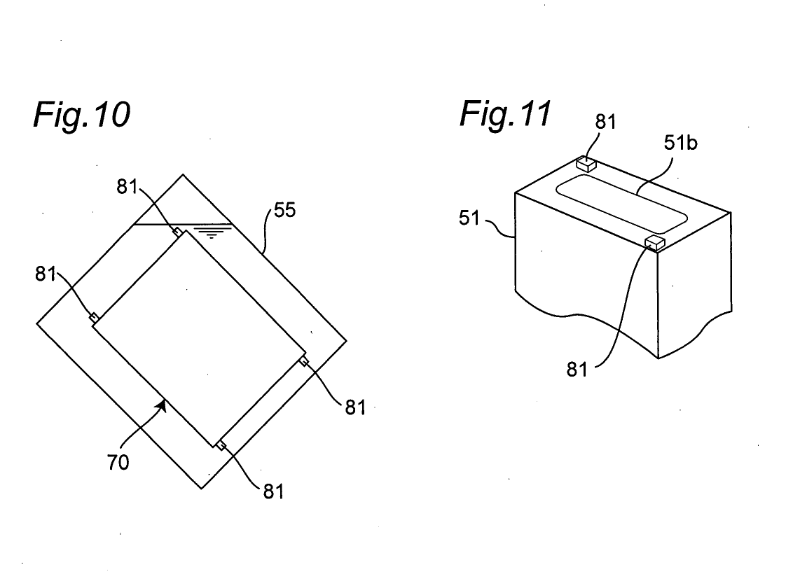

Thus, providing the respective liquid detection sensors 81 makes it possible to reliably detect whether or not the membrane electrode assembly 53 is exposed out of the liquid level in the case where, for example, the fuel cell body 70 is in an inclined attitude as shown in FIG. 10, and where the fuel cell body 70 is disposed upside-down. This makes it possible to provide a fuel cell system capable of taking various attitudes and suitable as a power source for portable electronic equipment.

According to the above-described first embodiment, various effects as shown below may be achieved.

First, in the fuel cell system 50, even when the liquid fuel contained in the intermediate tank 55 is vaporized due to the long-last power generation stopped state or the like, causing the liquid level to fall and putting the membrane electrode assembly 53 in the state of being exposed out of the liquid level, the liquid level of the intermediate tank 55 is detected by the level sensor 64 upon start of power generation, and if the fall of the liquid level is detected, the fuel pump 62 is driven to feed liquid fuel concentrate to the intermediate tank 55, making it possible to supplement the liquid fuel.

Thus, by supplementing liquid fuel in the intermediate tank 55 and starting power generation in the fuel cell body 70 in the state that the entire anode-side surface of the membrane electrode assembly 53 is completely immersed in the liquid fuel, it becomes possible to surely prevent the membrane electrode assembly 53 from being damaged without occurrence of the polarity reversal or the like.

Moreover, since driving of the fuel pump 62 for feeding liquid fuel concentrate to the intermediate tank 55 is executed by the electric power fed from the secondary battery 74, the fuel pump 62 can be driven without problems even before the start of power generation in the fuel cell body 70.

Further, by driving the fuel pump 62 by the electric power fed from the secondary battery 74 and supplementing a content of the liquid fuel in the intermediate tank 55 as described above, the supplementing operation can be performed regardless of the orientation of the entire fuel cell system 50, which makes the system suitable as a power source for personal digital assistances.

Further, in the fuel cell system in the first embodiment, such method as detecting, before the start of power generation, whether or not the liquid fuel extended (i.e., reached) the entire anode-side surface of the membrane electrode assembly, extending the liquid fuel to the entire surface if it is determined that there is a portion to which the liquid fuel is not extended, and then starting power generation in the fuel cell body to feed electric power is not limited to the fuel cell system of a membrane electrode assembly immersing-type, but is applicable to a type of the fuel cell system having such membrane electrode assembly and feeding liquid fuel to the membrane electrode assembly.

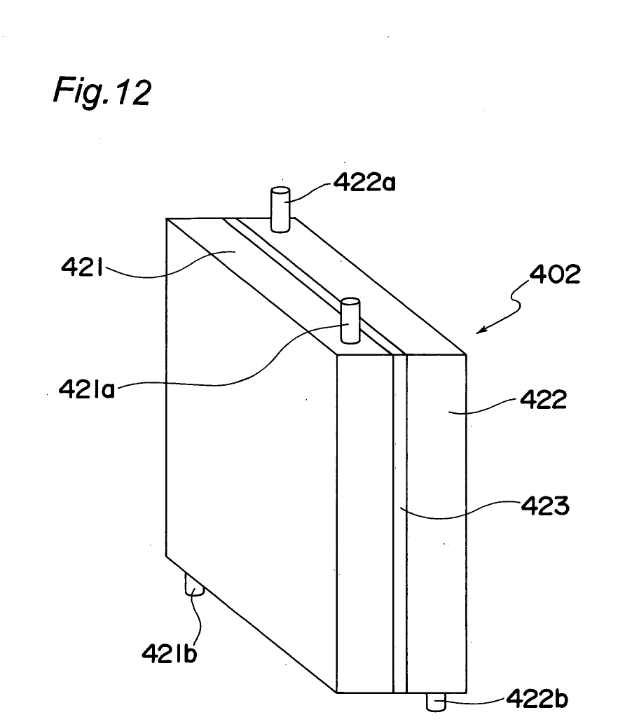

For example, a schematic perspective view showing a fuel cell body 402 which is included in such a type of the fuel cell system feeding liquid fuel to the membrane electrode assembly as one modified example of the first embodiment is shown in FIG. 12.

As shown in FIG. 12, the fuel cell body 402 has an anode 421, a cathode 422 and a membrane electrode assembly 423. It is to be noted that the cathode 422 and the membrane electrode assembly 423 are almost identical to the cathode 52 and the membrane electrode assembly 53, and therefore, description hereinafter will be focused on the structure of the anode 421.

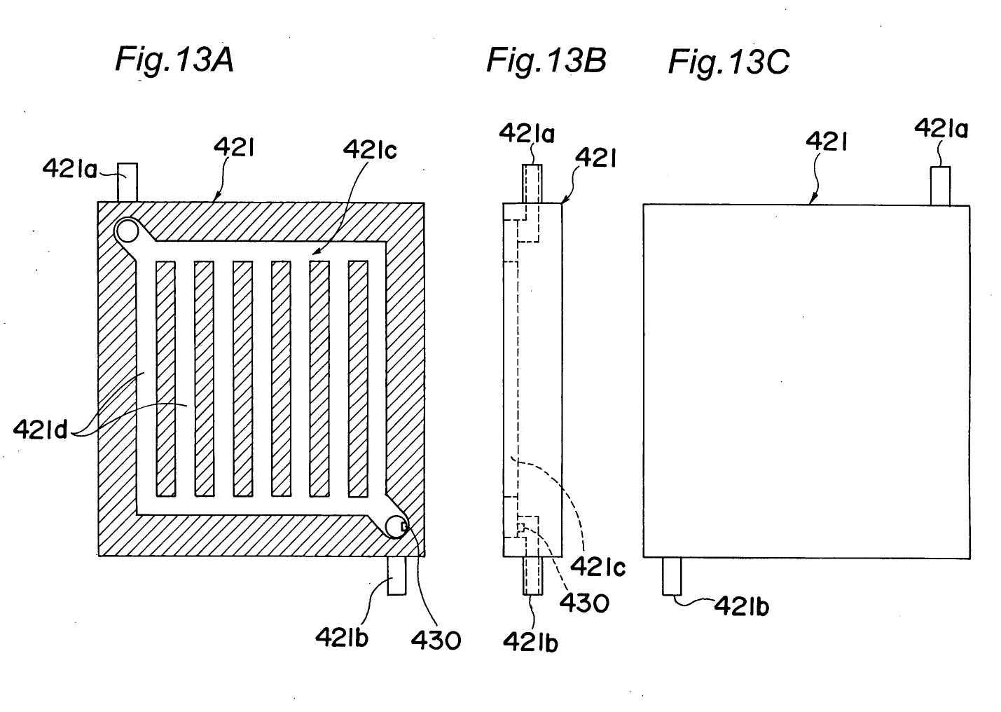

A schematic view showing the anode at a front face is shown in FIG. 13A, and a view at a side face is shown in FIG. 13B, and a view at a back face is shown in FIG. 13C. It is noted that the front face of the anode 421 is a surface which is placed against the side of the membrane electrode assembly 423. As shown in FIG. 13A, the anode 421 has a passageway 421c for the fuel which is connected from an inlet port 421a for the fuel to an outlet port 421b for the fuel. On the front face of the anode 421, some ditches 421d are formed and connected with each other. Therefore, by assembling the anode 421 and the membrane electrode assembly 423, and by covering each opening of the ditches 421d with the surface of the membrane electrode assembly 423, the passageway 421c is constructed inside of the ditches 421d, so as to pass through the fuel from the inlet port 421a to the outlet port 421b.

Further, the fuel cell system has a circulation pump (not shown) for feeding the fuel to the inlet port 421a of the anode 421 and for collecting the fuel form the outlet port of the anode 421. Some of the fuel which is fed into the passageway 421c is fed to the membrane electrode assembly 423 by contacting the fuel with the surface thereof and used for power generation. The other fuel which has not been used for the power generation is collected back form the outlet port 421b by the circulation pump. That is, the fuel is circulated through the passageway 421c by the circulation pump, and in such circulation of the fuel, some of the fuel is used for the power generation.

Furthermore, as shown in FIG. 13A, a fuel detection sensor 430 is placed around the outlet port 421b in the passageway 421c. The fuel detection sensor 430 is a sensor having a function to detect the contact with liquid, and may make use of, for example, thermistor-type liquid detection sensor.

Further, thus-structured fuel cell system is equipped with a control unit (controller, not shown) for controlling the operation of respective units and component members. The control unit is capable of controlling a liquid fuel feed operation by the circulation pump and also communicating with the fuel detection sensor 430.

Furthermore, the fuel cell system has a secondary battery which can feed electric power for driving each auxiliary equipment system even when power generating operation is not executed by the fuel cell body 402 and so the electric power by the power generation is not fed thereto.

Description is now given of the operation of respective units and component members when power generation is executed in thus-structured fuel cell system.

First, the fuel cell system receives a power generation start command. Based on the power generation start command, the control unit drives the circulation pump to feed the liquid fuel into the inlet port 421a and the control unit is communicated with the fuel detection sensor 430, then the detection result provided by the fuel detection sensor 430 is inputted to the control unit 430, which determines whether or not the fuel reaches at the outlet port 221b in the passageway 221c. It is to be noted that at this point, power generation by the fuel cell system is not yet started.

The liquid fuel passes through the passageway 421c and reaches the outlet port 421b. After that, the fuel detection sensor 430 detects that the fuel reaches the outlet port 421b. In such a condition, the fuel is filled in the passageway 421c and the surface of the membrane electrode assembly 423 covering the openings of the ditches 421d is fully contact with the fuel in the passageway 421c. Only after this state is gained, the fuel cell body 402 enters the state that allows start of power generation. Then, the control unit starts power generation in the fuel cell body 402, and electric power is generated by power generating operation.

However, if it is determined by the control unit that the fuel does not reach at the outlet port 421b, that is, if the fuel is not filled in the passageway 421c and if at least a part of the surface of the membrane electrode assembly 423 which covers the openings of the ditches 421d is not contact with the fuel in the passageway 421c, then the control unit prevents starting power generation in the fuel cell body 402 until the detection result indicates that the liquid fuel has reached the outlet port 421b.

According to the above-described modified example, it is possible to surely prevent the membrane electrode assembly 423 from being damaged without occurrence of the polarity reversal or the like.

Further, although description was given of the case where a plurality of the passageways 421c are formed in the anode 412, a single passageway such as a serpentine passageway may be used.

Furthermore, although description was given of the case where one fuel detection sensor 430 is placed around the outlet port 421b in the passageway 421c, a plurality of fuel detection sensors may be placed in the passageway 421c.

For example, the fuel detection sensor (a first fuel detection sensor) 430 is placed around the outlet port 421b in the passageway 421c, and a second fuel detection sensor is placed around the inlet port 421a in the passageway 421c. When the control unit receives a power generation start command and drives the circulation pump to feed the liquid fuel into the outlet port 421b through the inlet port 421a. Then, the control unit communicates with the first fuel detection sensor 430 and the second fuel detection sensor, and determines whether or not the fuel reaches at the outlet port 421b by the detection result of the first fuel detection sensor 430, and determines whether or not the fuel reaches at the inlet port 421a by the detection result of the second fuel detection sensor. Both of the first fuel detection sensor 430 and the second fuel detection sensor detect that the fuel reaches both of the outlet port 421b and the inlet port 421a. Then the control unit starts power generation in the fuel cell body 402.

However, if it is determined by control unit that the fuel does not reach either at the outlet port 421b or at the inlet port 421a, then the control unit prevents starting power generation in the fuel cell body 402 until the both of the detection results indicate reaching of the liquid fuel.

By placing a plurality of the fuel detection sensors in the passageway 421c, it is possible to detect reaching the fuel at a plurality of points in the passageway 421c. It becomes possible to detect reaching the fuel in the whole passageway 421c securely, more than placing only one fuel detection sensor.

Further, in the above-described, the second fuel detection sensor is placed around the inlet port 421a in the passageway 421c, it may be placed on the way of the passageway 421c.

### Second Embodiment

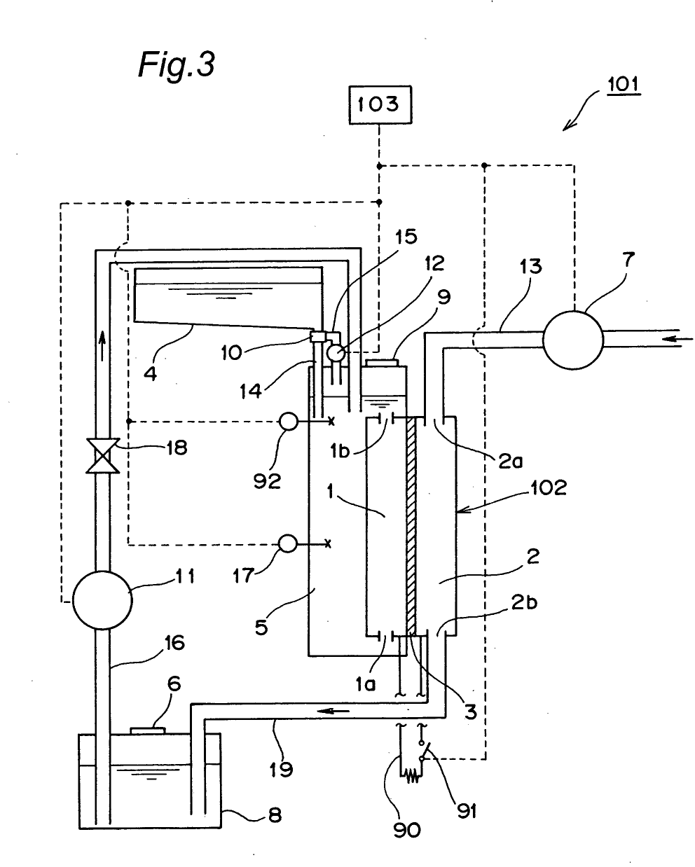

It is to be understood that the present invention is not limited to the above-described embodiment, but is applicable to other various embodiments. For example, a schematic structural view showing the schematic structure of a fuel cell system 101 according to the second embodiment is shown in FIG. 3. It is to be noted that the fuel cell system 101 in the second embodiment has the structure different from that of the fuel cell system 50 in the first embodiment on the point that the liquid fuel in the intermediate tank reduced during stop time of power generation is supplemented without the use of the electric power from the secondary battery. However, the structure regarding power generation in the fuel cell body (including the structure of auxiliary equipment systems) is almost identical to the that of the first embodiment, and therefore, description hereinafter will be focused on the difference therebetween.

As shown in FIG. 3, like the fuel cell system 50 in the first embodiment, the fuel cell system 101 is a Direct Methanol Fuel Cell (DMFC) for generating electric power with use of a methanol solution exemplifying organic liquid fuel as fuel by directly extracting protons from the methanol.

As shown in FIG. 3, a fuel cell body 102 has an anode (fuel pole) 1, a cathode (air pole) 2 and a membrane electrode assembly 3. Electrons extracted by the anode reaction move to the cathode 2 through a power generating circuit 90 which electrically connects the anode 1 and the cathode 2 via respective electrodes (unshown), whereas protons move to the cathode 2 through the membrane electrode assembly 3. Further, the cathode 2 has a function to set off the reaction (cathode reaction) to produce water through the reduction reaction with use of oxygen fed from the outside, the protons moved from the anode 1 through the membrane electrode assembly 3, and the electrons flowing in through the power generating circuit 90. Thus, the oxidative reaction in the anode 1 and the reduction reaction in the cathode 2 are respectively performed and electrons are sent through the power generating circuit 90, so that current is generated to allow power generation.

Further, as shown in FIG. 3, the anode 1 has a fuel feed port 1a provided inside for feeding a methanol solution and a discharge port 1b for discharging carbon dioxide produced by the anode reaction and a remaining methanol solution not used in the reaction from the inside.

The cathode 2 uses, for example, air, for feeding oxygen and therefore has an air feed port 2a for feeding the air to the inside of the cathode 2, and a discharge port 2b for discharging water that exemplifies the product produced by the cathode reaction and water from the inside.

Description is now given of the structure of the auxiliary equipment system in the fuel cell system 101. The auxiliary equipment system has auxiliary equipment for feeding a methanol solution to the anode 1 of the fuel cell body 102, auxiliary equipment for feeding air to the cathode 2, and auxiliary equipment for collecting water, i.e., a product produced in the cathode 2.

First, as shown in FIG. 3, the auxiliary equipment for the fuel feeding has an intermediate tank 5 exemplifying the first fuel container (or exemplifying the fuel container) for containing a methanol solution as liquid fuel so as to be fed to the anode 1, a liquid concentrate tank 4 exemplifying the second fuel container for containing a methanol solution with a concentration higher than that of the methanol solution contained in the intermediate tank 55 as liquid fuel concentrate so as to be fed to the intermediate tank 5, and a fuel feed unit for feeding the liquid fuel concentrate contained in the liquid concentrate tank 4 to the intermediate tank 5. Moreover, the liquid concentrate tank 4 is disposed at a position higher than the intermediate tank 5 and the lower portion of the liquid concentrate tank 4 is disposed above the upper portion of the intermediate tank 5. It is to be noted that the liquid concentrate tank 4 is, for example, a cartridge-type container mountable on the fuel cell system 101. In the fuel cell system 101, liquid fuel concentrate can be supplemented by dismounting the liquid concentrate tank 54 empty of the liquid fuel contained therein and mounting a new liquid concentrate tank 4 filled with liquid fuel.

The fuel feed unit is constituted so that the fuel feeding without the effect of power (electrical power) when power generation in the fuel cell body 102 is stopped (i.e. when the fuel cell system 101 is stopped) and the fuel feeding with the effect of power when power generating operation by the fuel cell body 102 is executed (i.e., when the fuel cell system 101 is operated) are selectively performed. More specifically, the fuel feed unit is composed of, for the fuel feeding without the effect of power, a first fuel feed pipe 14 exemplifying the fuel gravity feed section using the effect of gravity, a second fuel feed pipe 15 having a fuel pump 12 at some midpoint thereof that exemplifies the fuel power feed section with the effect of power, and a switch valve 10 for connecting the first fuel feed pipe 14 and the second fuel feed pipe 15 in a manner allowing connection to the lower portion of the liquid concentrate tank 4, and for selectively switching their connection to the liquid concentrate tank 4 (i.e., selectively switching so that a selected one is connected while the other is not connected).

Further, on the bottom surface of the liquid concentrate tank 4, there is provided a slope to obtain good dischargeability of the liquid fuel concentrate contained in the liquid concentrate tank 4 (dischargeability for feeding of the liquid fuel concentrate), and the switch valve 10 for connecting the first fuel feed pipe 14 and the second fuel feed pipe 15 to the liquid concentrate tank 4 is provided in the lowermost bottom portion or the vicinity thereof on the sloped bottom surface. It is to be noted that the liquid concentrate tank 4 is of sealed container structure except the connection portions to the first fuel feed pipe 14 and the second fuel feed pipe 15.

Moreover, the fuel feed end portion of the first fuel feed pipe 14 to the intermediate tank 5 is positioned slightly higher than the upper portion of the anode 1 disposed inside the intermediate tank 5. The switch valve 10 can be switched so that during stop time of power generation, the first fuel feed pipe 14 and the liquid concentrate tank 4 are connected and the second fuel feed pipe 15 and the liquid concentrate tank 4 are not connected (such a switching position is the first position), whereas during power generating operation, the second fuel feed pipe 15 and the liquid concentrate tank 4 are connected and the first fuel feed pipe 14 and the liquid concentrate tank 4 are not connected (such a switching position is the second position).

Further, as shown in FIG. 3, the anode 1 is disposed in the inner space of the intermediate tank 5, so that the entire anode 1 is completely immersed in the liquid fuel contained in the intermediate tank 5 in a fill-up state, i.e., the anode 1 is disposed below the liquid level of the contained liquid fuel. Thus, disposing the anode 1 in the intermediate tank 5 makes it possible to feed the liquid fuel into the anode 1 through the fuel feed port 1a that is constantly in the state of being immersed in the liquid fuel. Moreover, since the liquid fuel can be fed into the anode 1, the anode-side surface of the membrane electrode assembly 3 can be immersed in the liquid fuel, making it possible to constantly put the surface of the membrane electrode assembly 3 in a wet state. In other words, the membrane electrode assembly 3 is disposed in an immersed state below the liquid level of the liquid fuel contained in the intermediate tank 5.

Further, the intermediate tank 5 is provided with a gas-liquid separation membrane 9 for discharging gases such as carbon dioxide out of the intermediate tank 5. Further, the intermediate tank 5 is equipped with a concentration sensor 17 exemplifying the concentration detection unit capable of detecting the concentration of liquid fuel contained therein. It is to be noted that the concentration sensor 17 may use ultrasonic, capacitance or near-infrared multiwavelength optical concentration sensors.

The fuel pump 12 should preferably use, for example, a small-size positive displacement pump or the like, which in use can be, for example, intermittently driven to send out an appropriate amount of liquid fuel concentrate.

Further, the intermediate tank 5 contains, as the liquid fuel, a methanol solution with any concentration in the range of, at percent by weight, 1 to 10 wt %, preferably in the range of 3 to 10 wt %. In the initial state, the intermediate tank 5 contains a methanol solution with a concentration of 4.5 wt %. The liquid concentrate tank 4 contains a methanol solution higher in concentration than the liquid fuel contained in the intermediate tank 5 or methanol concentrate (i.e., methanol with a concentration of 100 wt %). In the initial state, for example, the liquid concentrate tank 4 contains a methanol solution with a concentration of 68 wt %.

Next, the auxiliary equipment for air feeding has an air feed pipe 13 exemplifying the air feed passageway whose one end is connected to the air feed port 2a of the cathode 2, and an air pump 7 exemplifying the oxygen feed unit (or exemplifying the air feed pump) disposed at some midpoint of the air feed pipe 13 for feeding air into the cathode 2 through the air feed pipe 13. As the air pump 7, a motor operated pump is used for example. Moreover, when power generation is executed in the fuel cell body 102, the air pump 7 is driven to feed necessary oxygen into the cathode 2, while when the power generation is stopped, the air pump 7 is stopped driving. It is noted that when the power generation is stopped, the fuel pump 12 is also stopped driving, and at the same time, the switch valve 10 is operated so as to connect the first fuel feed pipe 14 and the liquid concentrate tank 4 while interrupting the connection between the second fuel feed pipe 15 and the liquid concentrate tank 4.

Further, the auxiliary equipment for collecting water produced in the cathode has a discharge port 2b of the cathode 2, a water tank 8 exemplifying the product collecting container for collecting water produced in the cathode 2, and a water collection pipe 19 exemplifying the product collection passageway for connecting the discharge port 2b of the cathode 2 and the water tank 8 so that the above-produced water is collected into the water tank 8 from the discharge port 2b. Further, the water tank 8 is provided with a gas-liquid separation membrane 6 for discharging gases, i.e., air, out of the water tank 58. Moreover, there is provided a water feed pipe 16 exemplifying the product feed passageway for connecting the water tank 8 and the intermediate tank 5 for feeding water collected in the water tank 8 to the intermediate tank 5. At some midpoint of the water feed pipe 16, there are provided a water pump 11 exemplifying the product power feed section for feeding water with effect of power and a valve 18 for opening and closing the water feed pipe 16. It is to be noted in the second embodiment, the water feed pipe 16 and the water pump 11 constitute an example of the product feed unit. Further, in feeding water to the intermediate tank 5, controlling the operating time of the water pump 11 so that a concentration of liquid fuel in the intermediate tank 5 detected by the concentration sensor 17 should be a desired concentration for example, makes it possible to feed a necessary amount of water to the intermediate tank 5 through the water feed pipe 16 and the water pump 11.

Further, thus-structured fuel cell system 101 is equipped with a control unit 103 for controlling the operation of respective units and component members. The control unit 103 is capable of controlling a liquid fuel feed operation by the fuel pump 12, an air feed operation by the air pump 7, and a methanol solution concentration control in the intermediate tank 5 in a comprehensive manner while associating the respective operations to each other.

More precisely, the control unit 103 controls so as to drive the air pump 7 when power generation is executed in the fuel cell body 102 and to stop driving of the air pump 7 when the power generation is stopped. Moreover, the control unit 103 is also capable of performing control for stopping driving of the fuel pump 12 as well as control on the switch operation of the switch valve 10 at the same time as the air pump 7 is stopped driving.

Further, the control unit 103 is capable of controlling a feed amount of liquid fuel concentrate to the intermediate tank 5 and a collection amount of water collected (i.e., a feed amount of water) depending on the concentration of liquid fuel contained in the intermediate tank 5 detected by the concentration sensor 17. More specifically, the driving time of the fuel pump 12 and the driving time of the water pump 11 can be controlled depending on the detected concentration so that the liquid fuel contained in the intermediate tank 5 is maintained in a specified concentration range which is pre-determined in the control unit 103. The concentration range pre-determined in the control unit 103 herein refers to the concentration range of the methanol solution which allows generation of necessary electric power (necessary voltage and current) in the fuel cell body 102, which is set, for example, in the concentration range of 10 wt % to 1 wt %, more preferably 10 wt % to 3 wt %. It is to be noted that such concentration range that allows power generation is attributed to the cross over characteristic of the membrane electrode assembly 3. Therefore, it the cross over characteristic is improved and so an amount of methanol fed from the anode 1 to the cathode 2 through the membrane electrode assembly 3 is reduced, then the concentration range of 10 wt % or higher can be set as the concentration range that allows power generation.

Further, as shown in FIG. 3, in the fuel cell body 102, the power generating circuit 90 which electrically connects the anode 1 and the cathode 2 via respective electrodes (unshown) includes a circuit switch 91 (exemplifying the circuit-breaking switch) for breaking and making the circuit (i.e., for performing ON (connected)/;OFF (interrupted) operation). The ON/OFF operation of the circuit switch 91 can be performed by the control unit 103, and when power generating operation is conducted in the fuel cell body 102, the circuit switch 91 is put in ON state, in which the current generated in the power generating circuit 90 may flow, whereas when power generating operation is stopped, the circuit switch 91 is put in OFF state, in which the power generating circuit 90 is broken so as to block the current flow.

Further, the intermediate tank 5 is equipped with a liquid level sensor 92 exemplifying the content detection section for detecting the content of the liquid fuel. The liquid level sensor 92 has a function to detect that the liquid level of the liquid fuel contained in the intermediate tank 5 falls and a part of the membrane electrode assembly 3 is exposed above the liquid level. Moreover, in the case where the detection by the liquid level sensor 92 is conducted, the circuit switch 91 in the power generating circuit 90 is in OFF state or in the state that the OFF state is maintained so as to block the current from flowing into the power generating circuit in the fuel cell system 101.

Description is hereinbelow given of the operation of respective units and component members when power generation is executed in thus-structured fuel cell system 101. It is to be noted that the operation control over respective units and component members described hereinafter is performed by the control unit 103 in a comprehensive manner while the respective operations are associated to each other.

First, in the fuel cell system 101 shown in FIG. 3, a methanol solution (liquid fuel) with a concentration of, for example, 4.5 wt % is contained in the intermediate tank 5, while a methanol solution (liquid fuel concentrate) with a concentration of, for example, 68 wt % is contained in the liquid concentrate tank 4. The liquid fuel contained in the intermediate tank 5 is fed to the anode 1 through the fuel feed port 1a. Moreover, the content of the methanol solution in the intermediate tank 5 is to be a content with which the anode 1 disposed inside the intermediate tank 5 is completely immersed in the methanol solution, and a feed-side end portion of the first fuel feed pipe 14 is positioned below the liquid level of the contained methanol solution. Thus, containing the methanol solution in the intermediate tank 5 puts the anode-side surface of the membrane electrode assembly 3 in a state of being immersed in the methanol solution.

After that, the air pump 57 is driven and air, i.e., oxygen, is fed through the air feed pipe line 13 and the air feed port 2a. By this, an anode reaction is performed in the anode 1 while a cathode reaction is performed, in the cathode 2. At the same time, the circuit switch 91 of the power generating circuit 90 is put in ON state. Consequently, electric power is generated between the anode 1 and the cathode 2 or in the power generating circuit 90. Carbon dioxide generated by the anode reaction in the anode 1 goes into the intermediate tank 5 through the discharge port 1b, and further goes through the gas-liquid separation membrane 9 of the intermediate tank 5 before discharged out of the intermediate tank 5.

Water generated by the cathode reaction in the cathode 2 is sent to the water collection pipe 19 through the discharge port 2b by the pressure applied to the inside of the cathode 2 by the air pump 7, and transferred to the water tank 8 through the water collection pipe 19 and collected therein.

Further, by execution of the power generation, methanol and water from the methanol solution contained in the intermediate tank 5 are consumed. Consequently, in the intermediate tank 5, a fluid volume of the methanol solution decreases while a concentration of the methanol solution drops; By detecting the dropped concentration by the concentration sensor 17, a feed amount (supplement amount) of liquid fuel concentrate to the intermediate tank 5 and a collection amount (supplement amount) of collected water are determined in the control unit 103. Based on the determined respective feed amounts, the above feed amount of liquid fuel concentrate is fed from the liquid concentrate tank 4 to the intermediate tank 5 through the liquid concentrate tank 4, the second fuel feed pipe 15 and the fuel pump 12, while the above feed amount of water is fed from the water tank 8 to the intermediate tank 5 through the water pump 11, the valve 18, and the water feed pipe 16. In this case, the switch valve 10 is in the state of being switched so as to connect the second fuel feed pipe 15 and the liquid concentrate tank 4 while interrupting the connection between the first fuel feed pipe 14 and the liquid concentrate tank 4. By such feed operation of the liquid fuel concentrate and water to the intermediate tank 5, liquid fuel contained in the intermediate tank 5 is supplemented, while the concentration is maintained in a specified concentration range. Such operation is continuously and repeatedly performed in the fuel cell system 101, by which a necessary amount of electric power (specified electricity amount) is continuously generated in the fuel cell body 102.

When power generation is stopped in the fuel cell system 101, the circuit switch 91 in the power generating circuit 90 is turned OFF and the power generating circuit 90 is in an interrupted state. At the same time, the driving of the air pump 7, the driving of the fuel pump 12, and the driving of the water pump 11 are stopped. Further, the switch valve 10 is operated so that the connection between the liquid concentrate tank 4 and the second fuel feed pipe 15 is blocked while the liquid concentrate tank 4 and the first fuel feed pipe 14 are connected. Such state is a power generation stopped state in the fuel cell system 101, and this state is maintained when power generation is not executed.

The following description is given of the operation in the case where a content of the liquid fuel contained in the intermediate tank 5 is decreased in such power generation stopped state.

In the fuel cell system 101, when power generation is stopped, particularly power generation is stopped for a long period of time, liquid fuel contained in the intermediate tank 5 is vaporized and discharged out of the intermediate tank 5 through the gas-liquid separation membrane 9, causing the liquid level to fall. Such fall of the liquid level of the liquid fuel cause the feed-side end portion of the first fuel feed pipe 14 to be exposed above the liquid level in the intermediate tank 5. Due to the disposure out of the liquid level, air is introduced from the feed-side end portion to the first fuel feed pipe 14, and along with the introduction of air, liquid fuel concentrate is fed from the liquid concentrate tank 4 to the intermediate tank 5 through the first fuel feed pipe 14 without the effect of power but with the effect of gravity. The feeding of the liquid fuel concentrate is continued till the liquid level in the intermediate tank 5 rises and the feed-side end portion of the first fuel feed pipe 14 is positioned below the liquid level, i.e., immersed in the liquid fuel.

Moreover, even when the above-described supplement of the liquid fuel concentrate is performed upon stop of the power generation, it is considered that the liquid fuel concentrate contained in the liquid concentrate tank 4 may be depleted if the fuel cell system 101 is left unused for a longer period of time. In such a case, if the liquid level in the intermediate tank 5 falls, the liquid fuel concentrate cannot be supplemented, causing a part of the membrane electrode assembly 3 to be exposed above the liquid level. In this case, the fall of the liquid level, i.e., the exposure of the membrane electrode assembly 3, is detected by the liquid level sensor 92 provided in the intermediate tank 5, by which the circuit switch 91 in the power generating circuit 90 is in OFF state or in the state that the OFF state is maintained so as to block the current flow to the power generating circuit 90. This makes it possible to prevent that the fuel cell system 101 is started with the membrane electrode assembly 3 being exposed out of the liquid level and so the current flows through the power generating circuit 90, thereby inflicting damage on the membrane electrode assembly 3.

It is to be noted that in the second embodiment, if the fuel cell system 101 is disposed upside-down during stop time of power generation, the switch valve 10 is structured to be automatically switched from the first fuel feed pipe 14 side to the second fuel feed pipe 15 side, which prevents the liquid fuel in the intermediate tank 5 from accidentally flowing back to the liquid concentrate tank 4.

According to the second embodiment, various effects as shown below may be achieved.

First, in the fuel cell system 101, even when the liquid fuel contained in the intermediate tank 5 is vaporized due to the long-last power generation stopped state or the like, the liquid fuel can be supplemented to the intermediate tank 5 without the effect of power but with the effect gravity, making it possible to maintain the liquid level height in the specified range.

More specifically, in the intermediate tank 5, with the feed-side end portion of the first fuel feed pipe 14 being positioned above the liquid level along with the fall of the liquid level, the liquid fuel is fed from the liquid concentrate tank 4 to the intermediate tank 5 through the first fuel feed pipe 14 so as to raise the liquid level and recover the original state. Further, once the liquid level rises and the feed-side end portion of the first fuel feed pipe 14 is immersed again below the liquid level, the feeding of the liquid fuel concentrate from the first fuel feed pipe 14 can be stopped. Such feeding of the liquid fuel concentrate with use of the first fuel feed pipe 14 makes it possible to maintain, with the effect of gravity, the liquid level height of the liquid fuel contained in the intermediate tank 5 in an almost constant range, i.e., in the range of the liquid level height with which the liquid fuel is not spilled out of the intermediate tank 5 and the anode-side surface of the membrane electrode assembly 3 is immersed in the liquid fuel. Therefore, even if the fuel cell system 101 is not used for a long period of time and so the liquid fuel contained in the intermediate tank 5 is evaporated and diminished, the liquid fuel concentrate can be supplemented without the effect of power, which makes it possible to prevent the membrane electrode assembly 3 from being exposed out of the liquid level, thereby preventing a part or all of the membrane electrode assembly 3 from being put in a dry state. Therefore, it becomes possible to reliably prevent the membrane electrode assembly 3 from being damaged by occurrence of polarization in the membrane electrode assembly 3, which is caused by the fuel cell system 101 being started with the membrane electrode assembly 3 in the dry state.

During power generating operation in the fuel cell system 101, in order to maintain the liquid fuel contained in the intermediate tank 5 in the desired concentration range, the switch valve 10 is switched so that a necessary feed amount of liquid fuel concentrate can be fed from the liquid concentrate tank 4 to the intermediate tank 5 through the fuel pump 12 and the second fuel feed pipe 15, while a necessary feed amount of water is fed from the water tank 8 to the intermediate tank 5 through the water pump 11 and the water feed pipe 16. The respective feed amounts may be determined by the control unit 103 upon detection of the concentration of the liquid fuel contained in the intermediate tank 5 by the concentration sensor 17.

Moreover, during the power generation stopped state being maintained in the fuel cell system 101, if feeding of the liquid fuel concentrate is not possible due to the concentrate tank 4 being emptied or the like, and so the liquid level of the intermediate tank 5 falls, the fall of the liquid level can be detected by the liquid level sensor 92 in the intermediate tank 5 and the circuit switch 91 is put in OFF state to bring the power generating circuit 90 in the interrupted state. This makes it possible to prevent the membrane electrode assembly which is partially exposed out of the liquid level from being damaged by accidental startup of the fuel cell system 101.

### Third Embodiment

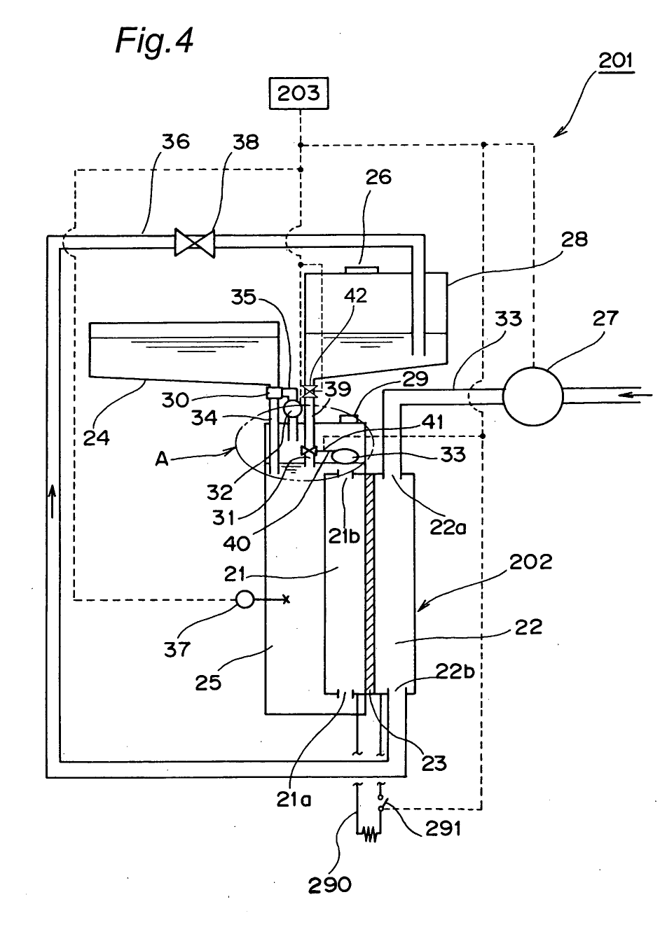

A schematic structural view showing the schematic structure of a fuel cell system 201 according to the third embodiment is shown in FIG. 4. As shown in FIG. 4, although the basic structure of the fuel cell system 201 is identical to the fuel cell system 101 in the second embodiment, the auxiliary equipment structure for collecting water produced in the cathode and the structure of water feeding are different. Description hereinafter will be focused on the different structure portions.

As shown in FIG. 4, the fuel cell system 201 has a fuel cell body 202 made up of an anode 21, a cathode 22, and a membrane electrode assembly 23. The fuel cell system 201 further has a power generating circuit 290 and a circuit switch 291 for connecting the anode 21 and the cathode 22 through respective electrodes (unshown).

The fuel cell system 201 also has an auxiliary equipment system similar to that of the fuel cell system 101 in the second embodiment, which is made up of an intermediate tank 25, a liquid concentrate tank 24, a fuel pump 32, an air pump 27 and a water tank 28.

More specifically, the fuel cell body 202 may be formed by using the Nafion 117 (trade name) made by DuPont as an electrolyte, forming carbon powder carriers with platinum and ruthenium, or an alloy of platinum and ruthenium being dispersed therein as an anode catalyst of the anode 21 on one surface of the electrolyte while forming carbon carriers with platinum particles being dispersed therein as a cathode catalyst of the cathode 22 on the other surface, then placing diffusion layers made of, for example, carbon paper respectively on the anode catalyst and the cathode catalyst in intimate contact so as to form the membrane electrode assembly 23, and then fixing the membrane electrode assembly 23 to a housing through a separator.

Further, as shown in FIG. 4, the anode 21 has a fuel feed port 21a provided inside for feeding a methanol solution so as to allow the anode reaction to be set off and a discharge port 21b for discharging carbon dioxide produced by the anode reaction from the inside.

The cathode 22 uses, for example, air, for feeding oxygen for use in the cathode reaction and therefore has an air feed port 22a for feeding the air to the inside of the cathode 22, and a discharge port 22b for discharging water (including water in both liquid phase or gas phase, and water in the mixed state of the both phases) that exemplifies the product produced by the cathode reaction and air from the inside. It is to be noted that the product contains water as a primary ingredient, and may contain other ingredients such as formic acid, methyl formate and methanol (by so-called cross over).

Description is now given of the auxiliary equipment structure for collecting water produced in the cathode 22 and the structure for feeding water with reference to FIG. 4.

As shown in FIG. 4, the auxiliary equipment for collecting water produced in the cathode is structured such that the discharge port 22b of the cathode 22 is connected to, for example, the water tank 28 exemplifying the product collecting container through a water collection pipe 36 and a valve 38 for collecting water. The water tank 28, which is disposed above the intermediate tank 25, is composed of a gas-liquid separation membrane 26 for discharging air and a water feed pipe 39 for feeding the water collected into the intermediate tank 25. It is to be noted that the bottom portion of the water tank 28 is given a slope and the water feed pipe 39 is connected to its lowermost portion, providing good dischargeability of water contained in the water tank 28.

Description is now given of the specific structure of the water feeding to the intermediate tank 25. As shown in FIG. 4, in the vicinity of a lower top end portion as viewed in the drawing (water feed-side end portion) of the water feed pipe 39, there is provided a water feed valve 31 for automatically opening and closing in response to the liquid level of the intermediate tank 25. The water feed valve 31 is connected to a float 33 for detecting the liquid level through a joint section 40. The joint section 40 is provided with a switch 41 (e.g., a limit switch), which is set to be OFF when the liquid level falls and the float 33 is at its lowermost position. It is to be noted that in the third embodiment, the float 33 exemplifies the content detection section.

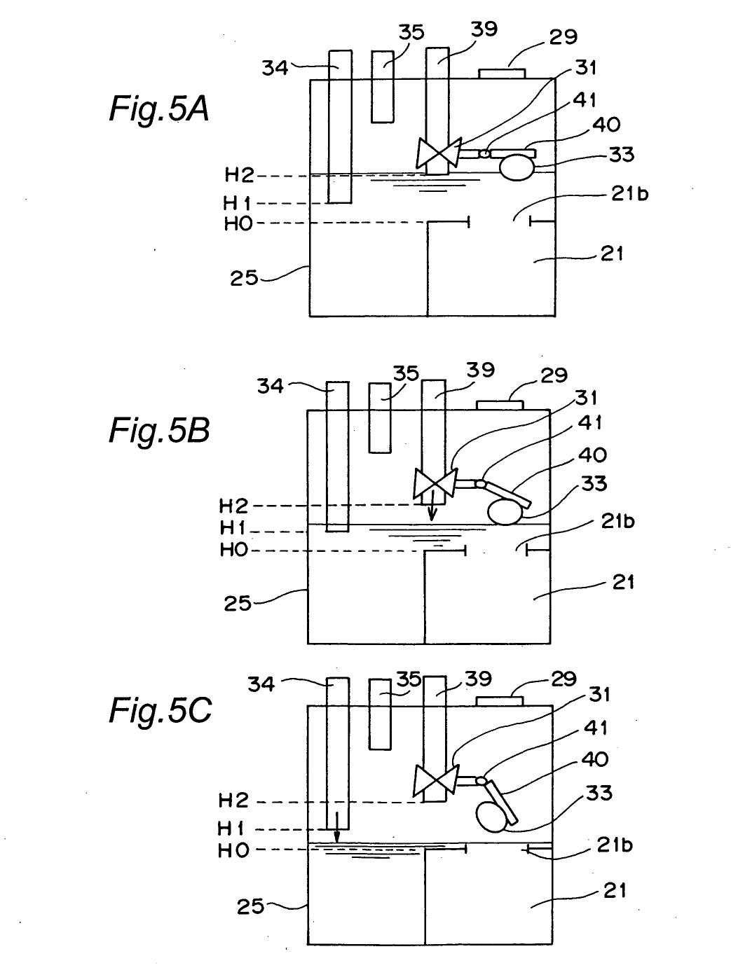

Herein, enlarged schematic views of A portion (i.e., the vicinity of the liquid level of the liquid fuel in the intermediate tank 25) in the fuel cell system 201 in FIG. 4 are respectively shown in FIG. 5A, FIG. 5B and FIG. 5c. It is to be noted that FIG. 5A, FIG. 5B and FIG. 5C respectively show respective states in the process that the liquid level of the intermediate tank 25 changes and falls sequentially. In each of FIG. 5A, FIG. 5B and FIG. 5C, a height position on the upper end of the anode 21 in the fuel cell body 202 is H0, a height position of the feed-side end portion of a first fuel feed pipe 34 is H1, and a height position of the feed-side end portion of the water feed pipe 39 is H2.

As shown in each of FIG. 5A, FIG. 5B and FIG. 5C, the feed-side end portion of the first fuel feed pipe 34 is positioned higher than the upper end of the anode 21, and the feed-side end portion of the water feed pipe 39 is disposed so as to position higher than the feed-side end portion of the first fuel feed pipe 34. Therefore, a relation of H0<H1<H2 is established among the respective height positions. Moreover, in each of FIG. 5A, FIG. 5B and FIG. 5C, the fuel cell system 201 is in the power generation stopped state.

Further, FIG. 5A shows the state in which the liquid level of the liquid fuel in the intermediate tank 25 is positioned almost at the same height position as the height position H2 of the feed-side end portion of the water feed pipe 39. In such a state, with the position of the float 33, the joint section 40 is almost horizontally disposed and the water feed valve 31 is in the close state, so that water is not fed through the water feed pipe 39. Moreover, the feed-side end portion of the first fuel feed pipe 34 is not in the state of being exposed out of the liquid level, so that feeding of liquid fuel concentrate is not performed.

Next, FIG. 5B shows the state in which the liquid level of the liquid fuel in the intermediate tank 25 is positioned below the height position H2 of the feed-side end portion of the water feed pipe 39 and positioned above the height position H1 of the feed-side end portion of the first fuel feed pipe 34. In such a state, the float 33 falls lower than that in FIG. 5A, so that the water feed valve 31 is in the open state. Consequently, water is fed from the water tank 28 to the intermediate tank 25 through the water feed pipe 39. With the feeding of water, once the liquid level in the intermediate tank 25 rises again to the vicinity of the height position H2, the float 33 also rises and the water feed valve 3 is closed again so as to stop water feeding through the water feed pipe 39. It is to be noted that as the liquid level in the intermediate tank 25 falls again from the state in FIG. 5A to the state in FIG. 5B, above-described operation is repeated and water is fed to the intermediate tank 25, by which the height position of the liquid level is maintained in the range of the height position H2 to H1.

Further, FIG. 5C shows the state in which water contained in the water tank 28 is depleted so that water cannot be fed to the intermediate tank 25 and so the liquid level of the liquid fuel further falls from the height position H1 to the vicinity of the height position H0. In such a condition, since the feed-side end portion of the first fuel feed pipe 34 is in the state of being exposed above the liquid level, liquid fuel concentrate is fed from the guide blocks 24 through the first fuel feed pipe 34 according to the same principle as described in the second embodiment. With the feeding of the liquid fuel concentrate, the liquid level of the intermediate tank 25 can be maintained in a specified height position range.

Further, in the state shown in FIG. 5 in which the guide blocks 24 is emptied, supplement of the liquid fuel concentrate cannot be conducted, which brings the liquid level of the intermediate tank 25 in a lowered state. In such a state, the switch 41 of the joint section 40 in the water feed valve 31 is put in OFF state, so that the circuit switch 291 is put in OFF state to interrupt the power generating circuit 290, by which the fuel cell system 201 is in the state that startup is impossible. This makes it possible to prevent that the fuel cell system 201 is started with the membrane electrode assembly 23 being exposed out of the liquid level as the liquid level of the liquid fuel in the intermediate tank 25 further falls afterward. Therefore, it becomes possible to prevent damage on the membrane electrode assembly 23 caused by execution of power generation with the membrane electrode assembly 23 in the state of being exposed above the liquid level and in the resultant dry state. It is to be noted that the fuel cell system 201 may be provided with an indication for notifying users or the like of a startup disabled state and the necessity of fuel supplement, or an out-of-fuel ramp to glow.

It is to be noted that the operation for power generation in the fuel cell system 201 in the third embodiment is similar to the operation of the fuel cell system 101 in the second embodiment and therefore the description thereof is omitted. Further, the operation control over respective units and component members in respective operations for power generation and respective operations during stop time of power generating operation is carried out by a control unit 203 in a comprehensive manner while the respective operations are associated to each other.

It is to be noted that in the third embodiment, if the fuel cell system 201 is disposed upside-down during stop time of power generation, a switch valve 32 is switched to the second fuel feed pipe 35 side to close the first fuel feed pipe 34, and in the water feed valve 31, the float 33 is moved to the direction to close the valve, which prevents the liquid fuel in the intermediate tank 25 from accidentally flowing back to the liquid concentrate tank 24 and the water tank 28.

Further, in the third embodiment, description was given of the case where water feeding from the water tank 28 to the intermediate tank 25 is performed through the water feed pipe 39 and the water feed valve 31 (exemplifying the product gravity feed section) without the effect of power but with the effect of gravity. However, the third embodiment is not limited to the above case. Instead of this case, like the embodiment of the fuel feeding, there may be provided, for example, a water feed pipe 39 and a water feed valve 31 for feeding water with the effect gravity, another water feed pipe and a water feed pump (exemplifying the product power feed section) provided at some midpoint of the water feed pipe for feeding water with the effect of power, and a switch valve for selectively switching respective feed pipes. In this case, like the case in the first embodiment, during power generating operation in the fuel cell system 201, a feed amount of liquid fuel concentrate and a feed amount of water to the intermediate tank 25 can be adjusted by controlling the driving of the fuel pump 32 and the water feed pump, which provides an advantage that the concentration of liquid fuel contained in the intermediate tank 25 can be adjusted. In the constitution of the third embodiment, such concentration adjustment is not available, and therefore the third embodiment is suitable for the case where a methanol solution with the concentration range which does not require the concentration adjustment, e.g., with the concentration range of 10 wt % or lower, is used as liquid fuel. It is to be noted that such concentration range is largely influenced by the cross over characteristic of the membrane electrode assembly 23, and therefore improving the characteristic makes it possible to enlarge the concentration range.

Further, in the fuel cell system 201 in the third embodiment, supplement of water is first carried out when a content of liquid fuel contained in the intermediate tank 25 is reduced during stop time of power generation. According to such a method, it is presumable that the concentration of the liquid fuel in the intermediate tank 25 is below the concentration range that allows power generation and therefore power generation in the fuel cell body 202 cannot be started. In order to solve such a problem, an automatic valve 42 which can perform opening and closing operation in response to an external signal is provided in the water feed pipe 39 in the vicinity of the outlet of the water tank 28, and the control unit 203 performs such control as to command a concentration sensor 37 to detect the concentration of the liquid fuel in the intermediate tank 25, and to close the automatic valve 42 to block the water feed pipe 39 so that supplement of water to the intermediate tank 25 is stopped if it is determined based on the detection result that the concentration is below the concentration range that allows power generation. As a result, liquid fuel concentrate is fed to the intermediate tank 25, which makes it possible to prevent the concentration from decreasing and enables power generation in the fuel cell body 202 to be started. Once the increase of the concentration is confirmed, the automatic valve 42 can be opened so as to restart supplement of water.

According to the third embodiment, even if the fuel in the intermediate tank 25 is naturally vaporized and its liquid level falls during stop time of power generation in the fuel cell system 201, liquid fuel concentrate and water can be fed to the intermediate tank 25 without the effect of power but with the effect of gravity, which allows constant feeding of liquid fuel from the intermediate tank 25 to the anode 21. This brings about effects that the intermediate tank 25 is not left in a reduced state and that no damage is inflicted on the membrane electrode assembly 23 due to the diminished liquid fuel upon startup of the fuel cell system 201.

Although in the above-described respective embodiments, description was given of the case where the Nafion 117 made by DuPont is used as an electrolyte included in the membrane and electrode assemblies 3, 23 and 53, there may be used, in place of the Nafion 117, sulfonated fluorine-based polymer typified by perfluorocarbon-based sulfonic acid, and hydrocarbon-based polymer such as polystyrene sulfonic acid and sulfonated polyether ether ketone groups as materials of the membrane having hydrogen ion conductivity.

Further, although description was given of the case where carbon papers are used as the diffusion layers in the respective embodiments, there may be used, in place of the carbon paper, foam metal (e.g., foam metal made of stainless materials) as the diffusion layer.

Moreover, in the above-described respective embodiments, there is used a methanol solution contained in the intermediate tank with any concentration in the range of 1 wt % to 10 wt %. However, the upper limit of such a concentration range is based on the cross over characteristic of the electrolyte in the fuel cell body. Therefore, if this cross over characteristic will be improved in the future, it becomes possible to use a methanol solution with a higher concentration (i.e., a concentration higher than 10 wt %).

Further, although it was described in the second embodiment and the third embodiment that liquid fuel is fed to the inside of the anodes 1, 21 through the fuel feed ports 1a, 21a, fuel may be fed from the discharge ports 1b, 21b if the liquid levels of the intermediate tanks 5, 25 are higher than the discharge ports 1b, 21b.

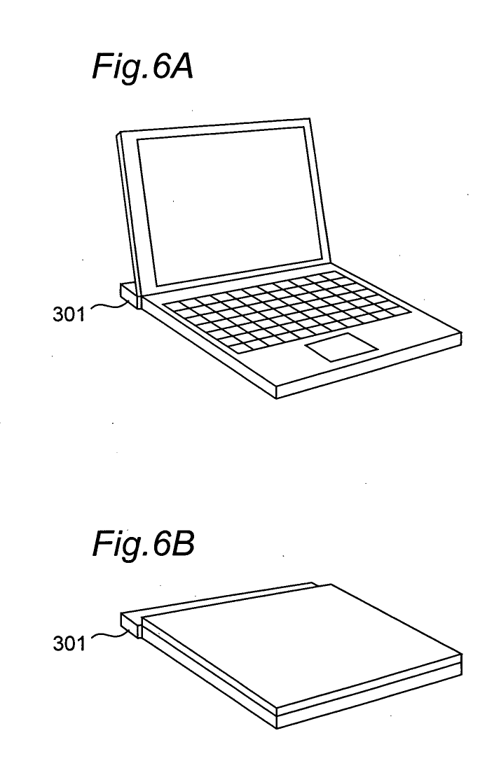

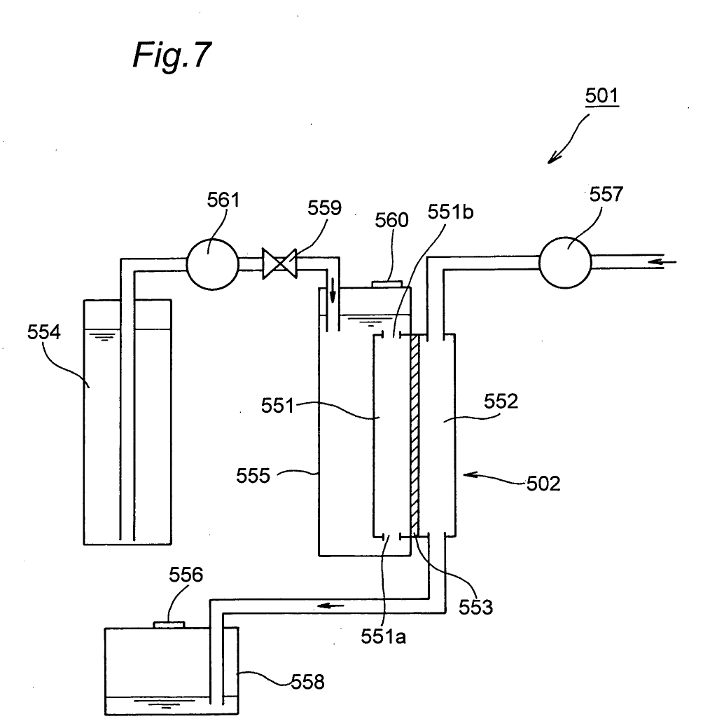

Further, FIGS. 6A and 6B are schematic perspective views showing the fuel cell system 50, 101 or 201 in the respective embodiments applied as the cell of a notebook-sized personal computer exemplifying the portable electronic equipment in the form of a fuel cell pack 301.

It is to be understood that among the aforementioned various embodiments, arbitrary embodiments may be properly combined so as to achieve the effects possessed by each embodiment.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

The disclosure of Japanese Patent Application No.2003-419485 filed on Dec. 17, 2003 including specification, drawing and claims are incorporated herein by reference in its entirety.

1. A fuel cell system comprising:
a fuel cell including an anode, a cathode disposed so as to face the anode, and a membrane electrode assembly disposed between the anode and the cathode;
a fuel pump for feeding liquid fuel to the anode wherein the anode is immersed when the liquid fuel reaches a top of the anode;
a fuel detector for detecting a level of the liquid fuel relative to the top of the anode;
a power supply for feeding electric power necessary for driving the fuel pump; and
a controller in communication with the fuel detector for activating the power supply if a detection result received from the fuel detector indicates that a level of the liquid fuel has not reached the top of the anode, and for preventing power generation in the fuel cell until the detection result indicates that the level of the liquid fuel has reached the top of the anode.

2. The fuel cell system as defined in claim 1, wherein the controller is operable to command the fuel pump to feed the liquid fuel and to allow the power generation in the fuel cell after the detection of the reach of the liquid fuel by the fuel detection section.

3. The fuel cell system as defined in claim 1, wherein the power supply is configured to supply power necessary for the detector to detect the liquid fuel.

4. The fuel cell system as defined in claim 1, further comprising a fuel container in which at least the anode of the fuel cell is disposed for containing the liquid fuel received via the fuel pump.

5. The fuel cell system as defined in claim 1, wherein the power supply is a secondary battery.

6. The fuel cell system as defined in claim 1, further comprising:
a first fuel container in which at least the anode of the fuel cell is disposed for containing liquid fuel; and
a second fuel container for containing liquid fuel with a concentration higher than that of the liquid fuel contained in the first fuel container;
wherein the fuel pump feeds liquid fuel from the second fuel container to the first fuel container.

7. The fuel cell system, comprising:
a fuel cell including an anode, a cathode disposed so as to face the anode, and a membrane electrode assembly disposed between the anode and the cathode;
a first fuel container in which at least the anode of the fuel cell is disposed for containing liquid fuel;
a second fuel container for containing liquid fuel having a concentration higher than that of the liquid fuel contained in the first fuel container; and
a fuel pump for feeding the liquid fuel from the second fuel container to the first fuel container during a power generating operation in the fuel cell; and
a switch valve disposed between the first fuel container and the second fuel container operative to feed the liquid fuel from the second fuel container to the first fuel container during a time when the power generation has stopped.

8. The fuel cell system as defined in claim 7, wherein
the second fuel container is disposed at a position higher than the first fuel container,
in a first position of the switch valve, the liquid fuel from the second fuel container flows to the first fuel container due to gravity, and
in a second position of the switch valve, the liquid fuel from the second fuel container flows to the first fuel container via the fuel pump.

9. The fuel cell system as defined in claim 8, further comprising a controller for detecting the power generation for switching the switch valve between the first position and the second position.

10. The fuel cell system as defined in claim 7, further comprising:
a power generating circuit for connecting the anode and the cathode;
a detector for detecting a content of the liquid fuel in the first fuel container; and
a circuit-breaking switch for activating the power generating circuit during the power generating operation, and for deactivating the power generating circuit during a stop time of the power generation, wherein
when the detector detects a content of the liquid fuel with which at least a part of the membrane electrode assembly is exposed out of the liquid fuel contained in the first fuel container, the circuit-breaking switch is deactivated or maintained in a deactivating state.

11. The fuel cell system as defined in claim 9, further comprising:
a product collecting container for collecting a product produced in the cathode by the power generation in the fuel cell; and
a recirculation pump for feeding the product from the product collecting container to the first fuel container.

12. The fuel cell system as defined in claim 11, wherein the product collecting container is disposed at a position higher than the first fuel container for feeding the product from the product collecting container to the first fuel container with effect of gravity.

13. The fuel cell system as defined in claim 12, further comprising a switch valve disposed between the product collecting container and the first fuel container operative to control feeding the product from the product collecting container to the first fuel container during power generation.

14. The fuel cell system as defined in claim 13, further comprising a concentration detector for detecting a concentration of the liquid fuel contained in the first fuel container, wherein
the controller is operable to control a feed amount of the liquid fuel concentrate fed to the first fuel container and a feed amount of the product fed to the first fuel container so that the concentration is within a predetermined concentration range.

15. The fuel cell system as defined in claim 11, wherein the product contains water as a main ingredient, and the liquid fuel contained in the first fuel container is the liquid fuel concentrate diluted by adding water.

16. The fuel cell system as defined in claim 7, wherein the liquid fuel is a methanol solution having a concentration in a range of 1 to 10 wt % that is a concentration range allowing the power generation, and the liquid fuel concentrate is a methanol solution having a concentration higher than that of the methanol solution or a methanol concentrate.

17. A fuel cell system comprising:
a fuel cell including an anode, a cathode disposed so as to face the anode, a membrane electrode assembly disposed between the anode and the cathode, and a power generating circuit for connecting the anode and the cathode;
a fuel container in which at least the anode of the fuel cell is disposed for containing the liquid fuel;
a content detector for detecting a content of the liquid fuel in the fuel container;
a circuit-breaking switch for activating the power generating circuit during the power generating operation, and for deactivating the power generating circuit during a stop time of the power generation; and
a controller for changing the circuit-breaking switch to a deactivating position or for maintaining the deactivating position when the content detector detects a content of the liquid fuel with which at least a part of the anode is exposed out of the liquid fuel contained in the fuel container.

18. A fuel system comprising:
a fuel cell including an anode which has a passageway of liquid fuel, a cathode disposed so as to face the anode and a membrane electrode assembly disposed between the anode and the cathode;
a fuel pump for feeding liquid fuel to the anode by passing through the liquid fuel from an inlet to an outlet of the passageway;
a fuel detector for detecting that the liquid fuel reaches the outlet of the passageway in the anode;
a power supply for feeding electric power necessary for driving the fuel pump; and
a controller in communication with the fuel detector for activating the power supply if a detection result received from the fuel detector indicates that the liquid fuel has not reached the outlet of the passageway in the anode, and for preventing power generation in the fuel cell until the detection result indicates that the liquid fuel has reached the outlet of the passageway.

19. A fuel system as defined in claim 18, further comprising a fuel detector which is placed in the inlet of the passageway or on the way of the passageway, for detecting that the liquid fuel reaches thereto, wherein
the controller communicates with the both fuel detectors and activates the power supply if either of detection results received from each of the fuel detectors indicate that the liquid fuel has not reached thereto, and prevents power generation in the fuel cell until both of the detection results indicate reaching of the liquid fuel.

20. A power generating method in a fuel cell system made up of a fuel cell including an anode, a cathode and a membrane electrode assembly, a first fuel container for containing liquid fuel, and a second container for containing a liquid fuel concentrate with a concentration higher than that of the liquid fuel, the method comprising the steps of:
immersing the anode in the liquid fuel during a stop time of power generation in the fuel cell; and
supplementing liquid fuel consumed by the power generation in the first container during the power generating operation in the fuel cell in order to perform continuous generation of a specified amount of electric power in the fuel cell.

21. A power generating method in a fuel cell system, comprising the steps of:
before staring power generation in a fuel cell,
detecting whether or not an anode is immersed in liquid fuel, and
feeding liquid fuel to the anode if it is determined based on a detection result that the anode is not immersed in liquid fuel until the anode is immersed in liquid fuel; and
generating power in the fuel cell after the anode is immersed in liquid fuel.
